(19) United States
(12) Patent Application Publication
(10) Pub. No.: US 2026/0272229 A1
(43) Pub. Date: Sep. 17, 2026

(54) BLENDING CONTAINERS WITH REDUCED OPEN END

(71) Applicant: Vita-Mix Management Corporation, Olmsted Township, OH (US)

(72) Inventors: Casey Zale, Olmsted Township, OH (US); Brad Paskert, Olmsted Township, OH (US)

(73) Assignee: Vita-Mix Management Corporation, Olmsted Township, OH (US)

(21) Appl. No.: 19/473,297

(22) PCT Filed: Apr. 10, 2024
(86) PCT No.: PCT/US2024/023864

§ 371 Date: Oct. 7, 2025

Related U.S. Application Data
(60) Provisional application No. 63/458,272, filed on Apr. 10, 2023.
(60) Provisional application No. 63/461,624, filed on Apr. 25, 2023.

(51) Int. Cl. A47J 43/046; A47J 43/07

(52) U.S. Cl. CPC A47J 43/046; A47J 43/0727; A47J 43/075

(57) ABSTRACT

Described are blending containers having a reduced open end, e.g., blending containers comprising a rim with a geometry that prevents access by items having a certain diameter or width, while still allowing one or more of portability, cleanability, pourability of blended foodstuff, and the like. The blending containers may be used in a blending system. The blending system may include frothers, foamers, aerators, and the like. The blending system may include a container selectively attachable to a motor base and including a frothing device. The blending system may include firmware logic and sensors to sense ingredients. The blending system may sense ingredients as they are added to the container, and may prevent blending until all ingredients or the certain quantity of ingredients have been added to the container. The blending system may provide more consistent and duplicable blends and may minimize user judgment or error.

### CROSS-REFERENCE TO RELATED APPLICATIONS

The present application claims priority to and the benefit of U.S. Provisional Application No. 63/458,272, entitled BLENDING CONTAINERS WITH REDUCED OPEN END, filed on Apr. 10, 2023, the entire contents of which are hereby incorporated by reference. The present application further claims priority to and the benefit of U.S. Provisional Application No. 63/461,624, entitled BLENDING CONTAINERS WITH REDUCED OPEN END, filed on Apr. 25, 2023, the entire contents of which are hereby incorporated by reference.

### TECHNICAL FIELD

The present disclosure relates to and blending containers having a reduced open end and blending systems, such as frothers, foamers, aerators, and the like, that include firmware logic and sensors to sense ingredients and provide more consistent and duplicable blends.

### BACKGROUND

There is a need for improved blending containers and blending containers having a reduced open end, e.g., blending containers comprising a rim with a geometry that prevents access by items having a certain diameter or width, while still allowing one or more (or all) of portability, cleanability, pourability of blended foodstuff, and the like, in an example. There is a need for improved blending systems such as frothers, foamers, aerators, and the like. More particularly, there is also a need for blending systems and frothing assemblies that provide one or more (or all) of the following benefits: easy to clean, portable, produce consistent product, minimize user error, minimize blending time, minimize equipment or steps, can assist in the evacuation of frothed liquid from the blending container, improved drive coupling, and the like. Additionally, there is a need for blending systems that automate and streamline the blending processes and that can provide duplicable blends.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

A blending container comprising a body is disclosed. The body comprises a first end defining an opening, a second end positioned opposite the first end, and a sidewall extending between the first end and the second end. The sidewall comprises a first indent extending toward a center of the blending container at the first end, the first indent having a first indent radius that is defined between the first indent and the center of the blending container. The sidewall further comprises a first channel positioned adjacent the first indent at the first end, the first channel having a first channel radius that is defined between the first channel and the center of the blending container. The first channel radius is greater than the first indent radius.

A blending container comprising a body is disclosed. The body comprises a first end defining an opening, a second end positioned opposite the first end, and a sidewall extending between the first end and the second end. The sidewall comprises a first projection extending toward a center of the blending container at the first end, the first projection reducing an area of the opening at the first end, and the first projection having a first projection distance defined between the first projection and the center of the blending container. The sidewall further comprises a first channel positioned adjacent the first projection at the first end, the first channel having a first channel distance defined between the first channel and the center of the blending container. The first channel distance is greater than the first projection distance.

A blending container comprising a body is disclosed. The body comprises a first end defining an opening, a second end opposite the first end, and a wall extending a wall length between the first end and the second end to define a cavity. The wall comprises a first projection extending toward a midpoint of the blending container, the first projection extending a projection length along the wall from the first end toward the second end, the projection length being different than the wall length, and the first projection having a first projection distance that is defined between the first projection and the midpoint of the blending container. The wall further comprises a first channel positioned adjacent the first projection, the first channel having a first channel distance that is defined between the first channel and the midpoint of the blending container. The first channel distance is greater than the first projection distance.

A blending system comprising a base and a blending container removably coupled to the base is disclosed. The blending container comprises a body comprising a first end defining an opening, a second end positioned opposite the first end, and a sidewall extending between the first end and the second end. The sidewall comprises a first indent extending toward a center of the blending container at the first end, the first indent having a first indent radius that is defined between the first indent and the center of the blending container. The sidewall further comprises a first channel positioned adjacent the first indent at the first end, the first channel having a first channel radius that is defined between the first channel and the center of the blending container. The first channel radius is greater than the first indent radius.

The following description and the drawings disclose various illustrative aspects. Some improvements and novel aspects may be expressly identified, while others may be apparent from the description and drawings.

### DESCRIPTION OF THE DRAWINGS

The accompanying drawings illustrate various systems, apparatuses, devices and methods, in which like reference characters refer to like parts throughout.

FIG. 1 is a functional block diagram of a blending system in accordance with various disclosed aspects herein;

FIG. 2 is a graphic depicting a chart of current or load draw of a blending system versus time in accordance with various disclosed aspects herein;

FIG. 3 is a flow diagram of an example method associated with a blending system in accordance with various disclosed aspects herein;

FIG. 4A shows a cross-sectional view of an embodiment of a blending system including a driver coupling in accordance with various disclosed aspects herein;

FIG. 4B shows an exploded view of an embodiment of a blending system including a driver coupling in accordance with various disclosed aspects herein;

FIG. 5 shows a perspective view of an embodiment of a blending device in accordance with various disclosed aspects herein;

FIG. 6 shows a front view of an embodiment of a blending device in accordance with various disclosed aspects herein;

FIG. 7 shows a top view of an embodiment of a blending device in accordance with various disclosed aspects herein;

FIG. 8 shows various views of an embodiment of a blending container in accordance with various disclosed aspects herein;

FIG. 9A shows various views of an embodiment of a blending container in accordance with various disclosed aspects herein;

FIG. 9B shows various views of an embodiment of a blending container in accordance with various disclosed aspects herein;

FIG. 9C shows various views of an embodiment of a blending container in accordance with various disclosed aspects herein;

FIG. 10A shows various views of an embodiment of a blending container in accordance with various disclosed aspects herein;

FIG. 10B shows various views of an embodiment of a blending container in accordance with various disclosed aspects herein;

FIG. 10C shows various views of an embodiment of a blending container in accordance with various disclosed aspects herein;

FIG. 11A shows various views of an embodiment of a blending container in accordance with various disclosed aspects herein;

FIG. 11B shows various views of an embodiment of a blending container in accordance with various disclosed aspects herein;

FIG. 11C shows various views of an embodiment of a blending container in accordance with various disclosed aspects herein;

FIG. 12 shows various views of an embodiment of a blending container in accordance with various disclosed aspects herein;

FIG. 13 shows various views of an embodiment of a blending container in accordance with various disclosed aspects herein;

FIG. 14 shows various views of an embodiment of a blending container in accordance with various disclosed aspects herein; and

FIG. 15 shows various views of an embodiment of a blending container in accordance with various disclosed aspects herein.

### DETAILED DESCRIPTION

Reference will now be made in detail to exemplary embodiments, examples of which are illustrated in the accompanying drawings, wherein like numbered aspects refer to a common feature throughout. It is to be understood that other embodiments may be utilized and structural and functional changes may be made. In addition, features of the various embodiments may be combined or altered. As such, the following description is presented by way of illustration only and should not limit in any way the various alternatives and modifications that may be made to the illustrated embodiments.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Furthermore, as used herein, the words “coupled,” “attached,” “connected,” and the like are utilized interchangeably unless contexts suggest otherwise. Such terms may mean removably (e.g. selectively coupled) or irremovably coupled. Furthermore, such terms may mean that articles or components may be or are capable of being coupled together. For instance, “G coupled with H” may mean that G is removably coupled with H, or G is irremovably coupled with H.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

Coffee-based drinks are very popular and are commonly served with a frothed liquid. It is also popular to serve other drinks, such as tea-based drinks, or chocolate-based drinks with frothed liquids. Some popular options for frothed liquids may include dairy items, such as milk, cream, skim milk, and the like, as well as non-dairy based items, including non-dairy creamers, almond milk, cashew milk, coconut milk, oat milk, other plant or nut based milks, and the like.

Blending or mixing foodstuff and liquids takes time to process. In commercial kitchens, consistency in blended or mixed products is very important. Thus, blending systems, including frothers, foamers, and aerators, as well as traditional blenders, food processors, and the like, may use programmed settings to run a particular blend cycle so that results maintain consistency.

Frothed liquids can be made at a café or restaurant by a stationary machine, such as a cappuccino machine, where steam is passed through a liquid to create a frothy consistency. These machines can be generally bulky, expensive, loud, and difficult to maintain.

Additionally, certain systems, such as those that are coupled to a motor base may froth a liquid. Even if using programmed settings to run a particular blend cycle, the user may start a blend cycle before, during, or after adding ingredients to the container. This may cause inconsistent results as the foodstuff may be blended for a shorter amount of time if the blend cycle is started prior to adding all the foodstuff for the recipe into the container.

Some systems for creating froth use wire whisks. These systems can include hand-held whisks, mug or cup mixing systems including a whisk, manual whisks, and powered whisks. Frothing of non-dairy liquids generally rely on hand-held units, which may be cumbersome and require the user to direct the hand-held whisk into the liquid during the entirety of the frothing process. Reliance on hand-held whisks can also decrease efficiency and may not be suitable for commercial applications, such as for use in cafés or restaurants. Wire whisks may also be difficult to clean as foodstuff may get stuck or trapped in the wires. Wire whisks may be susceptible to physical deformation (e.g., bending, breaking, etc.), rusting, or other damage if pressed against the container. Also, such use of hand-held systems may be reliant on the user's judgment and patience, which can result in inconsistent frothed products as the user decides where to position the whisk and when frothing is satisfactory.

It is noted that the various embodiments described herein may include other components and/or functionality. It is further noted that while embodiments may refer to a blender or a blender system, various other systems may be utilized in view of the described embodiments. For example, embodiments may be utilized in food processor systems, spice grinder systems, coffee grinder systems, mixing systems, hand-held blending systems, various other food preparation systems, and the like. As such, references to a blender, blender system, and the like, are understood to include food processor systems, and other mixing systems. Additionally and/or alternatively, the various embodiments described herein may be utilized in non-food preparation scenarios such as in medical and/or laboratory environments, for example.

Such systems generally include a blender base that may include a motor, a blade assembly, and a controller. Further, such systems may include a container, a display, a memory or a processor. A blade assembly, a blending container, and a blender base may removably or irremovably attach to one another. The blending container may be powered in any appropriate manner, such as disclosed in U.S. Pat. No. 10,638,886, entitled Powered Blending Container, which is hereby incorporated by reference in its entirety.

In addition, blending or whipping of foodstuff or ingredients may result in a blended product. Such blended products may include sauces, salad dressings, creams, egg products (e.g., meringues), drinks, frozen drinks, smoothies, shakes, soups, purees, sorbets, or the like. Such blended products may include drinks, frozen drinks, smoothies, shakes, soups, purees, sorbets, butter (nut), dips or the like. It is noted that various other blended products may result from blending ingredients. Accordingly, terms such as “blended product” or “drink” may be used interchangeably unless context suggests otherwise or warrants a particular distinction among such terms. Further, such terms are not intended to limit possible blended products and should be viewed as examples of possible blended products. While blending of “ingredients,” “contents” or “foodstuffs” is described, it is noted that non-foodstuff may be mixed or blended, such as paints, epoxies, construction material (e.g., mortar, cement, etc.), and the like.

It is noted that the blending systems may include any household blender and/or any type of commercial blending system, including those with covers that may encapsulate or partially encapsulate the blender. For instance, described embodiments may be utilized with a noise dampening cover or enclosure. Commercial blending systems may include an overall blending system, such as a modular blending system that may include the blender along with other components, such as a cleaner, foodstuff storage device (including a refrigerator), an ice maker and/or dispenser, a foodstuff dispenser (a liquid or powder flavoring dispenser) or any other combination of such.

As used herein, the phrases “blending process,” “blending program,” and the like are used interchangeably unless context suggests otherwise or warrants a particular distinction among such terms. A blending process may comprise a series or sequence of blender settings and operations to be carried out by the blending device. In an aspect, a blending process may comprise at least one motor speed and at least one time interval for the given motor speed. For example, a blending process may comprise a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

It is noted that the terms blender, blending systems, blending processes, blended products, and the like, may encompass frothers, frothing systems, frothing processes, and frothed products, and may be used interchangeably unless context suggests otherwise.

Traditional blending systems including a blade assembly do not froth or aerate a liquid, such as milk, to create a froth. In the past, frothing may have been completed by hand with a wire whisk or with a device specifically designed for frothing, such as a powered, handheld wire whisk. Some of these devices use metallic whisks that have a wound wire in a circular path. Such systems are often time-consuming, difficult to clean, easily damaged, and are overall cumbersome to use. Alternatively, frothing has been accomplished using steam such as in hot coffee related drinks. Devices that froth with steam are often loud, expensive, and large. Such devices also heat the liquid, which may be undesirable in some situations. For example, it may be desirable to include frothing in a cold (or not hot) drink such as a cold pressed-coffee drink. However, using a steamed froth mixed with the cold drink may result in a less than desirable drink. Not only can using a steamed froth undesirably change the temperature of the cold drink, using a steamed froth can also damage certain liquids. For example, milk can curdle if heated to a particular temperature making the drink undesirable and/or unsafe to consume.

Described are blending containers having a reduced open end, e.g., blending containers comprising a rim with a geometry that prevents access by items having a certain diameter or width, while still allowing one or more (or all) of portability, cleanability, pourability of blended foodstuff, and the like.

The blending containers may be used in a blending system. The blending system may include frothers, foamers, aerators, and the like. The blending system may include a container selectively attachable to a motor base and including a frothing device. The blending system may include firmware logic and sensors to sense ingredients, motor loads, states of the blending system, the like or a combination of any of the foregoing. The blending system may sense or detect the presence of ingredients as they are added to the container, and may prevent blending until addition of ingredients has stopped or a certain quantity or threshold amount of ingredients have been added to the container. The blending system may provide more consistent and duplicable blends and may minimize user judgment or error. The blending system may be used to froth dairy and non-dairy milks or creamers. The blending system may be portable and easy to clean, use with rinsers, rinse, store, and handle. The blending system may include a rechargeable power source. The frothing device may comprise a frothing disc, a blade, and/or a combination of the above, etc. A frothing disc may include channels or apertures and the rotation thereof may force ingredients through the channels or apertures to provide frothing, foaming, aeration, etc.

Described are blending containers having a reduced open end, e.g., blending containers comprising a rim with a geometry that prevents access by items having a certain diameter or width, while still allowing one or more (or all) of portability, cleanability, pourability of blended foodstuff, and the like.

The blending containers may be used in a blending system. The blending system may include frothers, foamers, aerators, and the like. The blending system may include a container selectively attachable to a motor base and including a frothing device. The blending system may include firmware logic and sensors to sense ingredients. The blending system may sense ingredients as they are added to the container, and may prevent blending until all ingredients or the certain quantity of ingredients have been added to the container. The blending system may provide more consistent and duplicable blends and may minimize user judgment or error. The blending system may be used to froth dairy and non-dairy milks or creamers. The blending system may be portable and easy to clean on rinsers. The blending system may be rechargeable. The frothing device may include channels or apertures and the rotation thereof may force ingredients through the channels or apertures to provide frothing, foaming, aeration, etc.

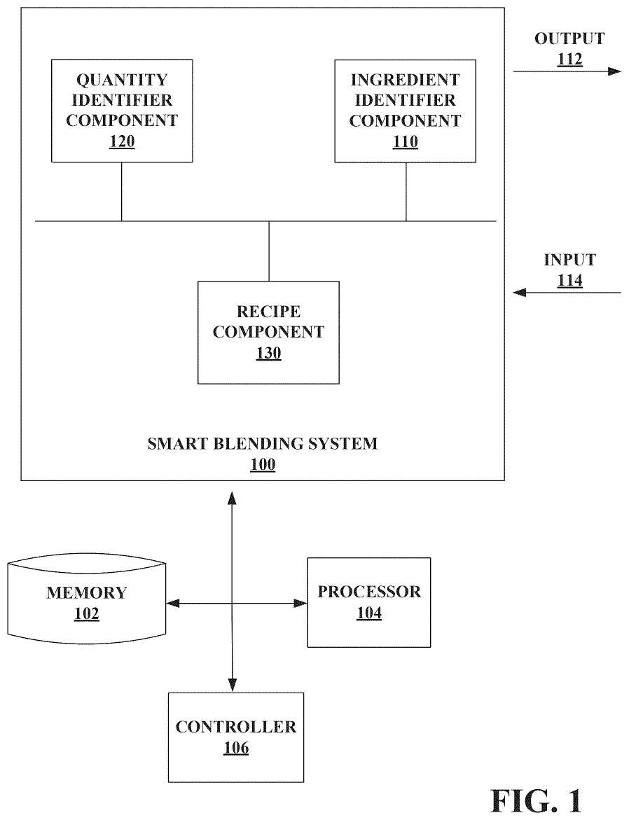

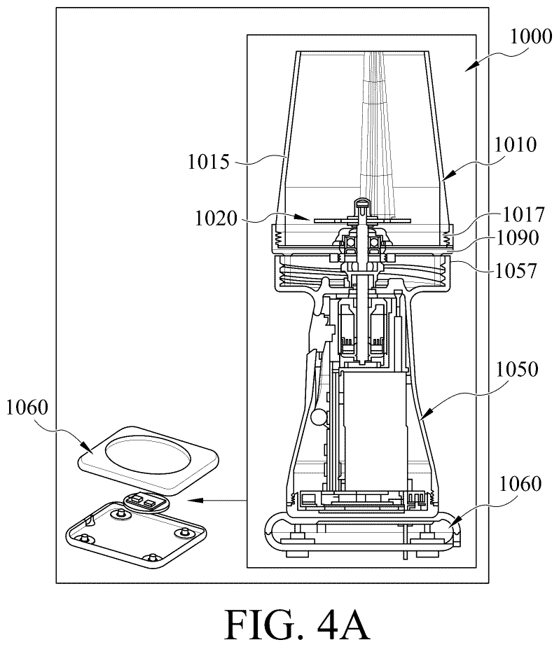

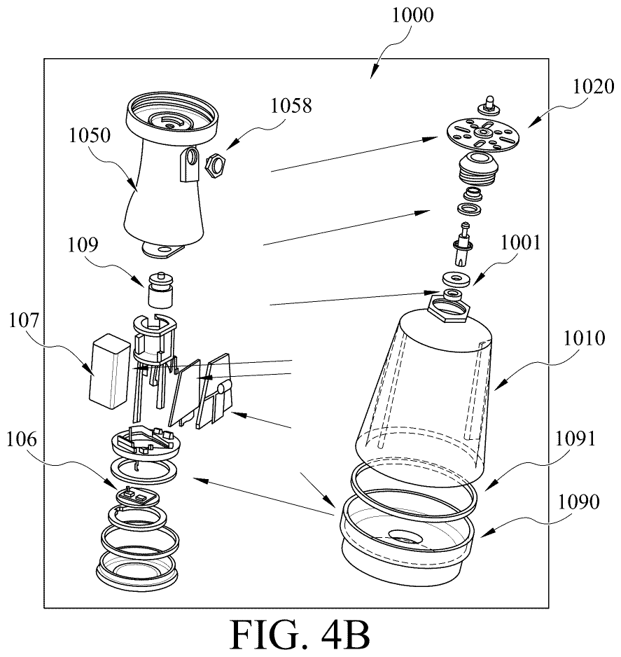

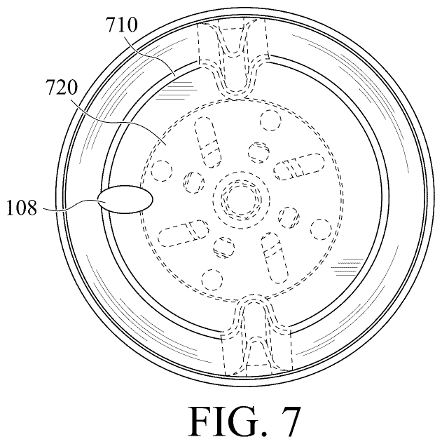

Turning to FIGS. 1-13, shown are blending system 100, and processes, functions, and methods thereof, and blending containers 1010, 710, 210, 310, 410, 510, 610 which may be integrated with or may communicate with the blending system 100. In an embodiment, blending system 1000 may include a container 1010, shown in FIGS. 4A and 4B. Blending system 1000 may further include a motor base 1050, shown in FIGS. 4A and 4B. The container 1010 may be selectively attachable to the motor base 1050 through mating attachment and/or engagement. Similarly, blending systems may include containers 710, 210, 310, 410, 510, 610 that are selectively attachable to corresponding motor bases. The blending systems may further comprise one or more sensors 108 and logic, as well as processors, memory, controllers, and the like, to sense certain inputs and output instructions such as start time, motor speed, blending time, and the like. It is noted that any of the containers 1010, 710, 210, 310, 410, 510, 610 described herein may be adapted to the systems, e.g., systems 1000, 700, 100 described herein, including corresponding motor bases, and the like.

In an example, the one or more sensors 108 and logic of the blending system 100 may be integrated into the motor base. In an example, the one or more sensors 108 and logic of the blending system 100 may be integrated into the motor base and the containers. For example, the blending system 100 may be integrated into the motor base and the sensors may be integrated into either or both the motor base and containers. It is also noted that the blending system 100 and sensors 108, or components thereof, may be separate from, but able to communicate with the blending systems.

In an embodiment and as described herein, the sensors 108 may be used to monitor and determine quantity information related to ingredients that are added to the containers of the blending systems. The sensors 108 may include weight sensors and may be positioned at the bottom of the container or on the motor base. The weight sensors may be of any appropriate configuration, such as one of a load cell, strain gauge, capacitance sensor, photoelectric sensor, hydraulic sensor, electromagnetic sensor, and pneumatic sensor. The sensors 108 may include point sensors that indicate when an ingredient reaches a certain position in the container. For example, a sensor 108 (such as a point sensor or a laser point sensor) may be positioned at a point on the container that measures 4 fluid ounces, 6 fluid ounces, 8 fluid ounces, 10 fluid ounces, etc. The containers may include a plurality of sensors 108 (such as point sensors and/or laser point sensors) along the containers. The sensors 108 may be positioned at singular points along the containers or the sensors may extend longitudinally along the containers, laterally and/or horizontally across the containers, or may circumscribe the interior of the containers.

Although the figures show different orientations of the sensors 108 for the different embodiments, it is noted that these positions of the sensors 108 are non-limiting and may be used with any embodiments described herein. For example, the bottom surface weight sensors 108 may be used with any of blending devices. In another example, height sensors 108 (such as point sensors and/or laser point sensors) may be used with any of the blending devices. Additionally, although the figures show sensors 108 in both the motor base and the container, it is noted that sensors 108 in only the motor base or in only the container may also be utilized. Additionally, sensors 108 in the lid, on the mating portions, on the frothing disc, and/or on the charging base, etc. may also be used. In addition to the foregoing, sensors 108 may include a temperature sensor, vibration sensor, light sensor, camera, microphone, pressure sensor, weight sensor, a photoelectric sensor, thermal sensor, motor load sensor (e.g., current sensor), motion sensor, timer and the like. The blending system 100 may use the readings from these various sensors 108 to adjust, modify, conduct, or practice certain blending programs so as to provide a blending product that is repeatable and with defined characteristics.

Using the quantity information obtained by the sensors 108, the blending system 100 as described herein, may actuate blending processes (e.g., actuate a motor controlled by a controller) only when certain quantities of or when less or more certain quantities of ingredients have been inputted into the containers. The blending system 100, firmware logic, and sensing components 108 may allow the resulting blended product or foam to be repeatable and robust no matter who is preparing the ingredients or drink. The processes and blending system 100 described herein may also be used for purposes other than recipe consistency, and can be adapted for food safety and user safety applications as well. In one example, the blending system 100 may utilize a temperature sensor 108 so that it will not operate if the temperature of the ingredients added to the containers exceeds a defined temperature.

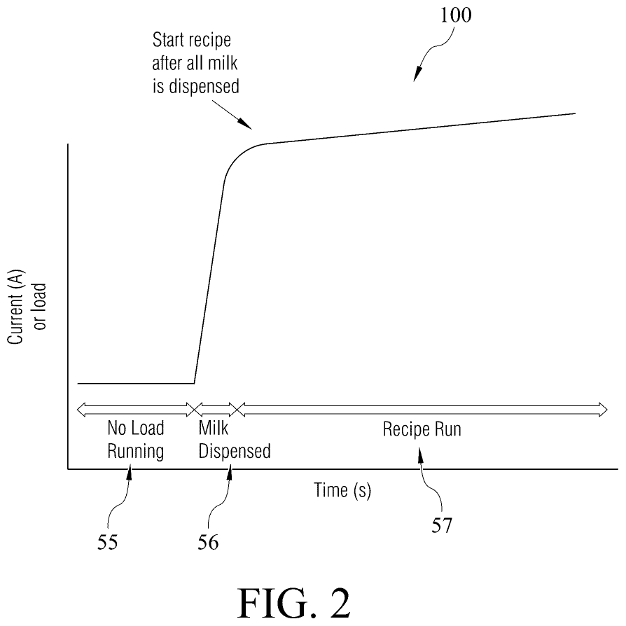

For example, as shown in FIG. 2, a user may be able to start the blending device without ingredients in the container. Once the sensors 108 and blending system 100 sense the load increasing or ingredients being added in the container to a certain point, it would begin the “recipe time” and would then complete the expected recipe length no matter of when the ingredients are put in the container. The blending device may also communicate with a dispensing system (e.g. a milk dispensing system) directly to know the speed and volume that is dispensed into the container. In this case, the container and blending system 100 would know exactly when to “begin” the expected recipe length. This could be done through a plurality of communication methods. Beginning recipe time or recipe length may include beginning blending or a blending process, such as beginning to turn on the motor, beginning to initiate the frothing device or blade assembly, or the like. The blending or blending process may be controlled by the controller.

In an embodiment, the blending or blending process or could be stopped or halted based on one or more actions. For example, blending or blending process or could be stopped or halted by tilting the handle, detecting a foreign object (such as a utensil), tilting of the blending device (e.g., the unit), rapid movement of the handle or blending device (e.g., dropping the unit), pressing of a button (e.g., the actuator or power button), or the like. In an example, the blending device may include an accelerometer, such as an accelerometer of any configuration.

The accelerometer may detect tilt or movement of the container. Stated another way, the accelerometer may detect instances where the container is picked up by a user, tilted by a user to dispense the container contents, and/or instances where the container is not aligned with the base properly, for example. The accelerometer may be able to detect different thresholds of tilt or movement (e.g., normal operation or blending, improper operation or blending, falling over or being dropped, being picked up, being rotated for pouring, etc.). The accelerometer may be able to determine type of tilt or movement (e.g., normal operation or blending, improper operation or blending, falling over or being dropped, being picked up, being rotated for pouring, etc.). In an example, if a user begins to tilt or pour the blending device or container, the accelerometer may detect or identify this movement and the blending device or motor thereof may shut off to prevent spilling. The accelerometer may also be able to detect vibrations in the container that exceed a defined threshold. This may alert the user to a potential issue in the operation of the blending system 100. The accelerometer may also be able to detect vibrations in the motor base if such vibrations exceed a defined amount. These excessive vibrations may be caused by a defect or an issue in the operating parameters of the blending system 100. The accelerometer detecting vibrations exceeding a predefined threshold may provide a notice to the user.

The accelerometer may be located at any location in the blending device including, for example, the container and/or the motor base. The accelerometer may communicate with, in an example, the controller 106, which may be utilized to notify a user of certain conditions of the blending system 100.

Turning to FIG. 1, the blending system 100 may include or communicate with a memory 102, a processor 104, a controller 106, and one or more sensors 108 (e.g., optionally in a network). Memory 102, such as a non-transitory, processor-readable storage medium, may be configured for storing computer executable components such as an ingredient component 110, a quantity component 120, and a recipe component 130. Processor 104 may facilitate operation of the computer executable components through communications with the controller 106. Based in communications from the processor 104, alone or together with the memory 102, the controller 106 may control one or more (or all) of the actuation, speed, acceleration, deceleration, operation time, etc. of the motor.

It is noted that the blending system 100 may include one or more devices, such as a user device, a blender device, and a scale. It is further noted that one or more devices may comprise, at least in part, these various components. For instance, a single component of the blending system 100 may be comprised by one or more devices. While shown as separate or distinct components, the components of the blending system 100 may be comprised by one or more components. Further, the blending system 100 may include a plurality of blending devices that may be linked together through a network and transceivers. These blending devices may be operatively linked with a server that may operate or otherwise update the plurality of blending devices.

In an embodiment, ingredient component 110 may identify or monitor ingredients added to a blending system. In an aspect, ingredient component 110 may receive input 114 comprising data that describes an ingredient, where the input 114 may be user inputted, input from a wireless device, input from a scanner that scans a bar code of a packaging, and/or the like, and may output information like executable blending instructions, such as blending processes, that are specific to the identified or monitored ingredients added to the blending system. The blending processes can include one or more of the actuation, speed, acceleration, deceleration, operation time, etc. of the motor.

The data may be user input in the form of text, voice input, selection of a prompt (e.g., user selecting a check box, etc.), or the like. For example, the user may type “almond milk” via an input device (e.g., touch screen, keyboard, etc.) of system 100, the user may speak a term or phrase into a microphone and ingredient component 110 may utilize a speech recognition process to determine the identity or other aspects of the ingredient, or the user to scroll through a list of ingredients and select a representation of almond milk (e.g., textual, graphical, etc.).

In another aspect, ingredient component 110 may include or may communicate with other systems, such as sensors, cameras, optical scanning devices, optical scanners, spectrometer, multi-wave length scanner, electronic noses, or the like. Based on input from the other systems, ingredient component 110 may determine an identity of an ingredient. Ingredient component 110 may utilize image recognition techniques to identify an image received as input 114. For example, a user may utilize user equipment devices, such as a smart phone or other camera device to capture an image of one or more ingredients. Ingredient component 110 may receive the image and identify one or more ingredients in the image. In another aspect, identified ingredients may be added to a list of ingredients for a current blending process.

It is noted that ingredient component 110 may utilize other methods or processes of identifying an ingredient, such as scanning a barcode, label, radio frequency identification (RFID) tag, or other identifier on a product or product packaging. This may be particularly useful in a commercial blending system whereby prepackaged foodstuff ingredients are used and stored for use with the blending system. The prepackaged foodstuff may include at least one of the aforementioned devices to communicate with the blending system 100 to identify the contents of the prepackaged foodstuff.

In an embodiment, quantity component 120 may detect, identify or monitor the presence or quantity of ingredients added to a blending system. In an aspect, quantity component 120 may receive input 114 comprising data that describes a quantity of an ingredient or detection of an ingredient, where the input 114 may be user inputted or based on input from a sensor, wireless device, etc., and may output information like executable instructions, such as a timer, signal to initiate a motor, blending processes, or the like based on the detected or identified quantity of ingredients added to the blending system. The blending processes can include one or more (or all) of the actuation, speed, acceleration, deceleration, operation time, etc. of the motor.

Quantity component 120 may include a scale, counter, sensor, or other device capable of determining a quantity, e.g., one or more sensors 108. For instance, quantity component 120 may include a scale that measures a weight or mass. It is noted that the scale may be comprised within a blending device or may be a standalone device. In various embodiments, quantity component 120 may determine a weight of an ingredient and may communicate, via a wireless or wired connection, the weight to ingredient component 110 or another component in the system, such as recipe component 130, memory 102, processor, 104, controller 106, etc. In some instances, quantity component 120 may not have wireless or wired communication capabilities. In such instances, a user may read a measurement from a display of quantity component 120 and may supply the measurement as input 114 to the blending system 100, such as through an interface (e.g., touch screen, etc.). In embodiments, a user may override measurement data from quantity component 120. For instance, a user may review a volume or weight of an ingredient and may alter the volume or weight.

It is noted that the ingredient component 110 may also determine a quantity associated with an ingredient (e.g., acting as both the ingredient component 110 and quantity component 120, and identifying type and quantity of ingredient based on user input, input from a sensor, wireless device, etc., or any combination thereof). The quantity may be based on received input 114. Input 114 may be user input, for example, such as a user entered volume, mass, or the like. Further, the quantity may be derived from an image, such as through use of a camera. For instance, ingredient component 110 may recognize a gradient mark on a measuring device (e.g., measuring cup, etc.) or a quantity indicator on a packaging. A sensor (e.g., temperature or pressure sensor) can identify where on the container the ingredients are added. In examples, the sensor may detect changes in temperature or pressure with a container. A camera may also be used to identify such by noting where on the gradient markings the ingredients come up to.

Recipe component 130 may store recipes (e.g., via memory 102) and output 112 blending instructions for recipes (e.g. to processor 104) for various drinks, smoothies, shakes, or the like. Such recipes may be predetermined (e.g., from database of recipes), received from a different device (e.g., shared by other user devices), or the like. In some embodiments, the recipe component 130 may receive a recipe or have a recipe inputted directly therein. In an example, a central office of a restaurant chain may modify a current or a plurality of current recipes or add or delete a recipe or a plurality of recipes for use by the entire restaurant chain or a set of predefined locations.

A recipe may include information associated with the ingredients (identity, quantities, statuses, characteristics, ratios, etc. that may be received by one or more components of the blending system 100 such as either or both the ingredient component 110 and quantity component 120) and a blending process (e.g., power settings, blade speeds, blending patterns, timing information, etc. that may be specific to the information associated with the ingredients).

In an embodiment, recipe component 130 may generate a blending process comprising instructions for a blender device (e.g., power settings, blade speeds, blending patterns, timing information, etc.). In an embodiment, recipe component 130 may determine the blending process based on determining attributes associated with content to be blended (e.g., identity, quantities, statuses, characteristics, ratios, etc.). For instance, recipe component 130 may include processes that determine a blending process based on type of ingredient (e.g., dairy or non-dairy milks), when all ingredients have been added to the container (e.g., the entire quantity of milk for a desired recipe), desired a consistency/texture of blending product (e.g., thickness, thinness, amount of aeration or frothing, etc.), a ratio of liquids to solids, a time associated with blending, a power usage associated with blending, a temperature change associated with blending, and the like. As described herein, the blending system 100 may monitor the addition and quantity of ingredients and may actuate blending processes only when the desired quantity of ingredients are sensed, such as all of the milk, sweetener, etc. to make a recipe.

Such blending processes may take the context of what is being blended in regards to the ingredients, statuses of ingredients, quantities of ingredients, and personal preferences or recommended consistencies or event temperature and may create a custom blending process or program based on those ingredients, statuses, quantities, order of addition of ingredients, and preferences to meet target thresholds. It is noted that various aspects may alter attributes of a finished product. For example, use of a fresh (not canned or frozen) raw carrot may result in a different consistency than use of a fresh (not canned or frozen) cooked carrot. Further, a raw and canned carrot may result in a different consistency than a raw and non-canned carrot. Moreover, a thawed (e.g., previously frozen) carrot may result in a different consistency than a raw (e.g., never frozen) carrot. Different types or dairy and non-dairy milks, different quantities of liquids for different sized drinks, different temperatures for cold foam or hot foam, etc., may require specific blending processes to achieve a desired blended product. The blending system 100 may adjust the blending process and/or blending parameters to account for use of a different status of an ingredient. This may allow the blending system 100 to produce a consistent blended product regardless of the status of the ingredient (e.g., fresh, frozen, raw, cooked, etc.).

In embodiments, the blending system 100, including either or both the ingredient component 110 and a quantity component 120, may monitor or determine presence, addition, and subtraction of ingredients. In an aspect, ingredient component 110 may record a time associated with an ingredient being added to a container of a device. In some embodiments, the blending system 100 may determine a time associated with a blending process based on information received from quantity component 120.

Users may attempt to activate a blending process before, during, or after adding foodstuff to a container. If the blending program is run based on a time from actuation (e.g., a button press), the consistency of the end product may be different based on when the user added ingredients. For instance, as shown in FIG. 2, a user may turn on the blending system 100 at time 55. From 55 to time 56, no ingredients are added to the container. At time 56, a user may begin dispensing ingredients into the container, such as a dairy or non-dairy milk. The user may add ingredients up to time 57. Once the user finishes adding ingredients, the blending system 100 may initiate a blending recipe, such as a timed recipe at one or more speeds. For example, the blending system 100 may initiate a timer at time 57, and may automatically turn of a motor after passage of a predetermined amount of time. It is noted that the blending system 100 may initiate the motor at any time from time 55 onward, but typically no later than time 57.

During time 55 to time 56, the blending system 100, such as via the quantity component 120, may determine that no ingredients have been added to the container. As an example, the quantity component 120 may include a current sensor that senses a load on the motor based on current drawn by the motor. If the current meets a threshold associated with no ingredients in the container, the quantity component 120 may determine that no ingredients have been added. The current sensor may monitor or obtain additional readings to determine if and when a load is applied to the blades and hence to the motor. In these embodiments, the current sensor can sense the amount of current draw being applied to the motor. When the current draw increases, a load is applied to the blades. The quantity of ingredients may correlate to a current draw based on a correlation factor. The correlation factor may be utilized in an algorithm to determine the quantity.

In FIG. 2, the current sensor detects a change in current draw at about time 56 as ingredients, such as milk, are dispensed into the cup. The blending system 100 begins to sense a load as indicated by the upward slope of the graph. The time that ingredients are added is shown as the “milk dispensed” arrow. This time lasts as long as the user may take to dispense all desired quantities of ingredients (e.g., as sensed by the quantity component 120).

At time 57, the user may stop adding ingredients for the recipe to the container and the quantity component 120, such as through a current sensor, may detect that current draw has reached a threshold, is not changing, or is not changing a certain amount for a period of times (e.g., such as a minimum change over a period of time readings). At this time, the current sensor determines that no ingredients are being added and the processor 104 may initiate a blending program, such as a time program.

It is noted that FIG. 2 describes an example scenario. In other scenarios, a user may add some or all ingredients into the container before pressing an actuator. The quantity component 120 may detect whether these scenarios occur based on determining whether measured current draw at activation equals a threshold, is changing a certain amount over a period, or is not changing a certain amount over a period. If when an actuator is pressed, the quantity component 120 (such as the weight sensor) detects a quantity at a specific threshold indicating that the container is full, the blending system 100 may initiate a blending program. Likewise, if when the actuator is pressed, the quantity component 120 detects a quantity is changing, it may act as described above between times 56 to time 57.

As described herein, ingredients added to a container may indicate a load. The load or ingredients may be sensed according to various manners, including, without limitation, via a load sensor, a point sensor, a weight sensor, a temperature sensor on the motor that would measure an operating temperature thereof and then determine the load that causes such temperature. In addition, a capacitive or inductive sensor may also be utilized. Further still, a speed sensor may be utilized where the speed of the blade unloaded is determined and then as load is added, the speed slows down and can be measured to determine the amount and type of ingredients.

In an embodiment, the quantity component 120 may include one or more point sensors positioned to detect liquid at a certain position in a container. Beginning at time 55, the point sensor may determine that ingredients are not at a desired position. The point sensor or sensors may identify that liquid is being added at from time 55 to time 56. The point sensor or sensors may monitor the level of liquid and determine that it meets a threshold at time 57, which may be associated with a desired level to initiate a blending program (e.g., a timer). When this threshold level is reached, the quantity component 120 may send a notification to the processor 104, which may initiate the blending program that controls a motor and terminates driving the motor after a period of time or a consistency is reached.

According to other embodiments, the quantity component 120 may include one or more weight sensors positioned to detect liquid weight or mass added in a container. Beginning at time 55, the weight sensors may determine that ingredients are not at a desired weight and/or no liquid is added. The weight sensors or sensors may identify that liquid is being added at from time 55 to time 56 based on a change in weight. The weight sensors or sensors may monitor the weight of liquid and determine that it meets a threshold at time 57, which may be associated with a desired quantity to initiate a blending program (e.g., a timer). When this threshold level is reached, the quantity component 120 may send a notification to the processor 104, which may initiate the blending program that controls a motor and terminates driving the motor after a period of time or a consistency is reached.

In an aspect, the blending system 100 may analyze what has been added and identify for the user that the identified end product is not obtainable based upon the recipe being used. Further, the blending system 100 may notify the user or may modify (or send notification to so modify) the recipe or processing parameters based upon the ingredients added. For example, the blending system 100 may analyze (such as through any manner, including, without limitation those described herein) the added ingredients. The blending system 100 may identify that too much or too little of a particular ingredient was added that would result in a consistency that is not preferred, such as through measurements using the weight sensor or sensors. The blending system 100 may modify directly or send notification to modify the blending time to account for the over-added or under-added ingredient.

It is noted that a blending process may comprise instructions that generate notifications for actions to be executed by a user, such as addition or subtraction of an ingredient. For example, the blending process may instruct an interface (e.g., a screen of a smart phone or tablet) to display a prompt that prevents blending or motor operation if a particular quantity of an ingredient is not detected (e.g., “please add 2 more ounces of milk,” “1 cup of milk not detected.” etc.) or requests a user to add an ingredient after a certain amount of blending has occurred (e.g., “please add 1 cup of ice”). Indications may be made via a user interface, such as a monitor, LED, audio device, tactical, haptics or vibration, or the like.

In addition, recipe component 130 may generate or select one or more sets of instructions for a recipe, such as a blending process. One or more blending processes may be stored, such as in memory 102. For example, memory 102 may store a set of preconfigured blending processes. The blending processes may comprise a series or sequence of blender settings and operations to be carried out by the blending device. For example, a blending process may comprise a series of blender motor speeds to operate the frothing disc at the given speed, a series time intervals corresponding to the given motor speeds, and other blender parameters and timing settings. The blending processes may further include a ramp or ramp up period that defines the amount of time it takes or the rate at which the motor gets up to the predetermined motor speed.

In an aspect, recipe component 130 may generate output 112 as instructions to implement the recipe or blending process, such as through communications to the processor 104 and controller 106. Blending systems 1000, 700 may include integrated blending systems 100 or the blending system 100 may communicate with the blending systems 1000, 700 and the blending systems 1000, 700 may be capable of receiving and executing instructions from the blending system 100 of the blending process. Blending containers 1010, 710, 210, 310, 410, 510, 610 may be used with blending systems 1000, 700 and blending system 100. It is noted that communicating the recipe, or other information, may comprise any wired or wireless connection, including, without limitation, Wi-Fi communication, cellular communication, wired communications, or the like. For instance, blending system 100 may utilize near field communication. In near field communication data may be exchanged (e.g., recipes) between devices when they are brought into a predefined close proximity of each other, including, without limitation the container and the process of the blending device.

While various sensors, such as weight and/or point sensors 108 are described herein, it is noted that blending system 100 and blending systems, e.g., the containers, may include any kind of sensor that may sense or detect any aspect of the ingredients added, including identity, quantity, etc. The sensor 108 may be integrated into or otherwise attached with the containers.

In an embodiment, the blending system 100 may facilitate the automatic initiation of a blending program, detection of blended drink completion, or the like by detecting the presence of material in the container when running. In an embodiment, the blending system 100 may detect viscosity of blended material to determine blended drink completion based on input such as the type of ingredients (e.g., milk or milk alternatives), such as via a flowmeter, current draw, optical sensors, etc. In an embodiment, the blending system 100 may detect the presence of ingredients or liquid and initiate a predetermined time out. The blending system 100 may support “in-flight” blending and provide consistency in blending and blended product.

In an embodiment where based on a blending program comprising a timed blending process, a user may press an actuator (e.g., start or power button of the blending system 100). The blending system 100 may power on, but would not initiate a countdown timer until ingredients are detected. It is noted that the blending system 100 may initiate the motor or may prevent initiation of the motor. The blending system 100 may monitor for addition of ingredients. Once the blending system 100 detects the ingredients and or a desired amount of ingredients, the blending system 100 may initiate the countdown timer and/or the motor. The blending system 100 may operate the motor at predetermined speeds or power until the countdown timer ends. At such point, the blending system 100 may terminate or end driving of the motor. In some embodiments, the blending system 100 may indicate that the blending program has completed via an interface, such as LEDs, audio device, display screens, etc.

In an example, conventionally, if a user were to walk up to a milk dispenser and milk is being dispensed into the container, a user would need to wait until all the milk is dispensed into the container to press the start or power button. Pressing the start or power button earlier than when all the milk is dispensed would cause inconsistency in the blended drinks because some of the ingredients would be blended more or less than others depending on the operator and when the start or power button was pressed. If a user started the unit before the ingredients are dispensed, the unit would clock out before it would have a chance to blend the ingredients properly. The blending system 100 allows the user to press the start or power button at any time (before, during, or after dispensing) while ensuring the ingredients are blended for the appropriate or desired time for every use so that the blended products are generally consistent.

Timing drink production is reliable and repeatable. The method ensures if a user pressed the button too early that the unit would keep running until the true start timer is initiated which would give the drink the proper amount of time to finish, which would result in a consistent product regardless of who operated the blending system 100.

The difference between empty and loaded may be detected by the blending system 100. Once liquid is detected, the blending system 100 will keep running but under the countdown timer, this will then give the planned drink consistency no matter if it is thinner alternative milk or a thicker heavy cream, or any other ingredient combination. The blending system 100 may employ an algorithm to detect and sense the presence of liquid and initiate blending. For example, the blending system 100 may use simple minimum threshold, artificial intelligence (AI) detected change (parameter-efficient language model tuning (PELT), constants change of a differential equation, variable change, training, etc.), and the like. In an embodiment, the blending system 100 may detect the presence of liquid (and not necessarily whether the liquid is done) such as through use of the sensors described above.

While described embodiments of the blending system 100 may refer to a predetermined time for blending to provide a blended product and adjusting the start time for blending based when ingredients are dispense, it is noted that the blending system 100 may monitor and evaluate other aspects to determine when a blended product is desirably blended. For example, the blending system 100 may monitor and evaluate viscosity of the blended product. In various instances, a sensor, such as a viscosity sensor can be used to detect a viscosity of the blended product. The desired viscosity may differ between different types of milk.

While examples of blending or frothing milk or other liquids are provided, it is noted that other ingredients may be blended or mixed. For example, a user may add a liquid, ice cubes, fruit, or other ingredients for mixing. Embodiments described herein may be utilized with such ingredients.

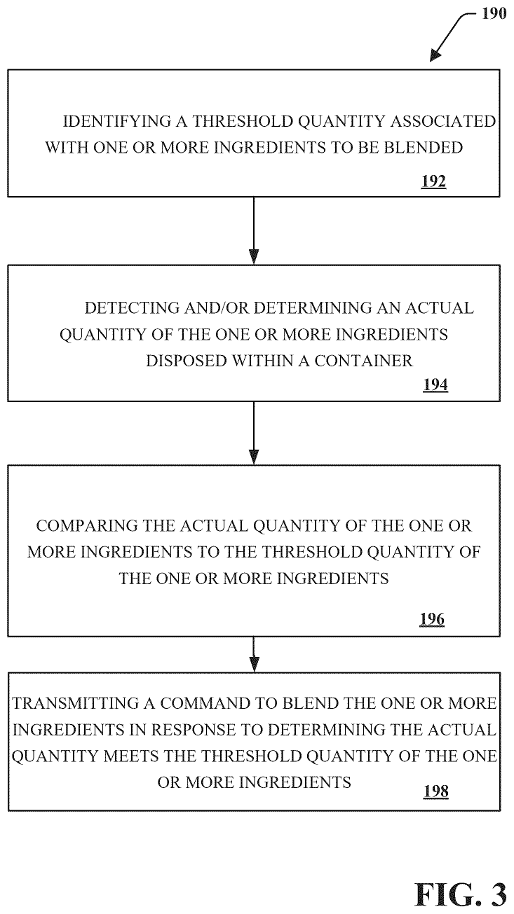

Turning to FIG. 3, shown is a flow diagram for a method 190 for a blending system, e.g., blending system 100. The method 190 may include step 192 for identifying a threshold quantity associated with one or more ingredients to be blended. This step 192 may be carried out by the blending system 100, and the identity component 110 and/or quantity component 120 thereof, a control, the controller, microcontroller, etc.

The method 190 may include step 194 for detecting presence and/or amount of ingredients within a blender container. In an embodiment, sensors 108 (such as the weight or point sensors described above) may quantify or detect ingredients as the ingredients are added to the container. In an embodiment, sensors 108 may determine an actual quantity of the ingredients disposed within the container.

The method 190 may include step 196 for comparing the actual quantity of the one or more ingredients to the threshold quantity of the one or more ingredients. At this step 196, the blending system 100, and/or the identity component 110, quantity component 120, and/or recipe component 130 thereof, may receive the sensor information relating to an actual quantity and compare the sensor information to a desired or threshold quantity based on a recipe or blending preference. This step 196 may be carried out by the blending system 100, and the identity component 110 and/or quantity component 120 thereof, a control, microcontroller, the controller, etc.

The method 190 may include step 198 for transmitting a command to begin blending the one or more ingredients in response to determining the actual quantity meets the threshold quantity of the one or more ingredients. The step 198 (or a different step) may prevent operation of the blending system 100 if the quantity of ingredients detected does not meet the threshold quantity. This would prevent the blending system 100 from operating unless the appropriate amount of ingredients have been added. The method 190 may include step 198 for transmitting a command to a motor of the blending system to begin driving the motor in response to determining the actual quantity meets the threshold quantity of the one or more ingredients. At step 198, the method 190 may include transmitting data instructing the blending device to blend the one or more ingredients based at least in part on the parameters regarding presence and/or amount of ingredients. This step 196 may be carried out by the blending system 100, a control, the controller, etc.

The method 190 may further include detecting button actuation. The method 190 may further include driving the motor for a predetermined amount of time after determining the actual quantity meets the threshold quantity. The method 190 may further include in response to determining the actual quantity does not meet the threshold quantity, preventing or delaying operation of the motor until the actual quantity meets the threshold quantity. This step may be carried out by the blending system 100, a control, the controller, etc.

The method 190 may further include overriding the step for determining if the actual quantity meets the threshold quantity and transmitting a command to a motor of the blending system to begin driving the motor regardless of the actual quantity. The command to a motor of the blending system to begin driving the motor regardless of the actual quantity may be initiated by a second actuation signal. This step may be carried out by the blending system 100, a control, the controller, etc.

The method 190 may further include transmitting a command to a motor of the blending system to terminate driving the motor based on a predetermined amount of time of blending, tilt of the blending system, or actuation. This step may be carried out by the blending system 100, a control, the controller, etc.

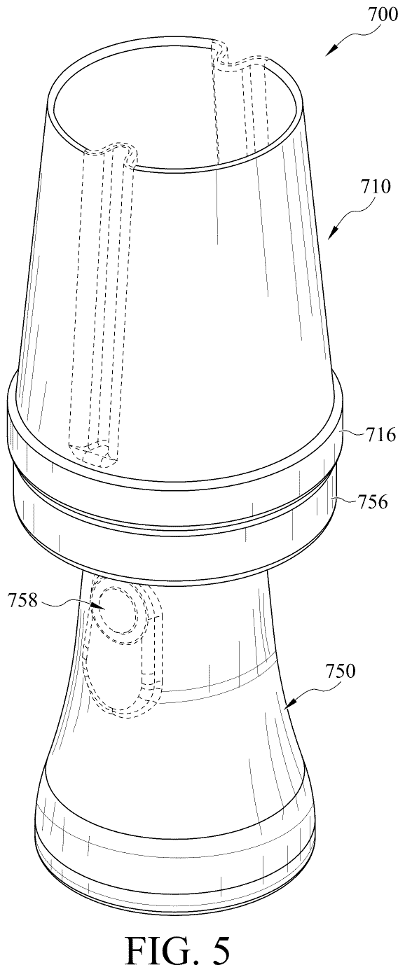

Turning to FIGS. 5-7, blending system 700 includes a container 710, a motor base 750, and a charging base 760. The container 710 may be selectively attachable to the motor base 750 and the motor base may be selectively attachable to the charging base 760.

The container 710 may include a body 715, a mixing assembly 720 (such as a blade assembly, frothing disc or blade, bearings, splined coupler, etc.), and a lid. The body 715 may include a bottom end 716 that is selectively attachable to the motor base 1050, a bottom surface, and a top end that is selectively attachable to the lid. As described, the container 710 may include one or more sensors positioned on any or all the body 715, mixing assembly 720, or lid, including any or all the bottom end 716, bottom surface, and top end of the body 715.

The motor base 750 may include a mating portion 756 configured to receive and selectively attach with the container 710, e.g., the bottom end 716 of the container 710. A power button or switch 758 may be positioned on the motor base 750. The motor base 750 may include an outer wall or shell that is sized and shaped for ergonomic blending allowing for handheld or single hand operation of the blending system 700. The motor base 750 may not include an extended neck and handle, as included in motor base 1050. The motor base 750 may include a flush mating surface and a smaller circumference body or curved in body, to enable easy grabbing of the motor base 750 by a user's hand. The motor base and/or the container 710 may comprises the sensors 108 as described above. This may result in the blending system 700 operating as described above.

Turning to FIGS. 4A and 4B, blending system 1000 may include a container 1010, a motor base 1050, and a charging base 1060. The container 1010 may be selectively attachable to the motor base 1050 via an adapter 1090, in an example, and the motor base 1050 may be selectively attachable to the charging base 1060. The charging base 1060 may comprise an inductive charging element. The motor base 1050 may then be capable of being inductively charged when placed on top of the charging base 1060. The motor base 1050 may comprise a rechargeable battery of any appropriate configuration. In these embodiments, the blending system 1000 may operate via the battery in the motor base 1050—the blending system 1000 may be portable. Alternatively or in addition, the motor base 1050 may comprise a power source that can accept AC power and may comprise a power cord configured to be electronically attached with a power source, such as an outlet.

The container 1010 may include a body 1015, a mixing assembly 1020 (such as a blade assembly, frothing disc or blade, bearings, splined coupler, etc.). The body 1015 may include an open end 1017 that is selectively attachable to an adapter 1090. The adapter 1090 may be selectively attachable the motor base 1050 in any appropriately mating manner. As described, the container 1010 may include one or more sensors (such as sensors 108) positioned on any or all the body 1015, mixing assembly 1020, or adapter 1090, including any or all the open end 1017.

The motor base 1050 may include a mating portion 1057 configured to receive and selectively attach with adapter 1090 (and thereby with the container 1010, e.g., the open end 1017 of the container 1010). A power button or switch 1058 may be positioned on the motor base 1050. The motor base 1050 may include an outer wall or shell that is sized and shaped for ergonomic blending allowing for handheld or single hand operation of the blending system 1000—this is particularly useful if the motor base 1050 comprises a battery making the blending system 1000 a handheld and portable device. The motor base 1050 may not include an extended neck and handle, as included in motor base 250. The motor base 1050 may include a flush mating surface and a smaller circumference body or curved in body, to enable easy grabbing of the motor base 1050 by a user's hand.

The blending system 1000 may include articulating drive coupling 1001 as shown in FIG. 4B. The motor base 1050 may further include a controller 106, battery 107, and motor 109. The container 1010 may include a seal 1091 between the open end 1017 of the container 1010 and the adapter 1090. The seal 1091 may provide a fluid-tight seal between the open end 1017 of the container 1010 and the adapter 1090 so that ingredients will not leak from the open end 1017 of the container 1010 and the adapter 1090 when the container 1010 and the adapter 1090 are inverted for placement on the motor base 1050. The battery 107 may power the motor 109. The battery 107 may be charged by placement of the motor base 1050 on the charging base 1060. Motor 109 operation may be controlled by the controller 106 as described herein, and the controller may initiate, delay, and stop an operation of the motor 109 based on one or more inputs from sensors 108, accelerometers, time elapsed, user actuation, secondary actuation, and the like. The motor 109 may drive the mixing assembly 1020 and provide mixing of ingredients within the container 1010.

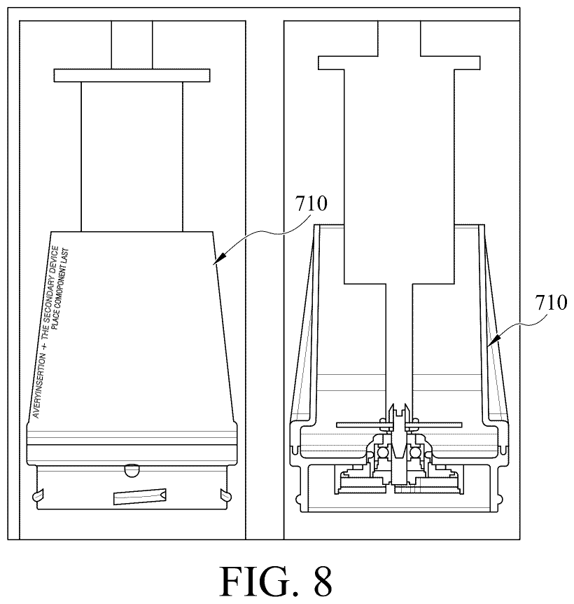

Turning to FIGS. 8-13, shown are embodiments of containers 210, 310, 410, 510, 610 that may be used with blending systems 700, 1000, e.g., that may be selectively attachable to a corresponding motor base and used for blending foodstuff. Containers 210, 310, 410, 510, 610 may include any of the disclosed aspects of containers 1010, 710 unless the context or this disclosure suggests otherwise. For example, containers 210, 310, 410, 510, 610 may include a blade assembly at a closed end and may comprise a rim at an open end.

In an embodiment, containers 210, 310, 410, 510, 610 may have the same heights as each other and as container 710. In an embodiment, containers 210, 310, 410, 510, 610 and container 710 may have a height of approximately 10.65 inches with the handset attached. In an embodiment, containers 210, 310, 410, 510, 610 may have a reduced open end, e.g., comprising a rim with a geometry that prevents access by items having a certain diameter or width, while still allowing one or more (or all) of portability, cleanability, pourability of blended foodstuff, and the like. In an embodiment, the containers 210, 310, 410, 510, 610 may have a rim geometry smaller than about 50 mm diameter or that prevents access of objects having about a 50 mm or greater diameter to the interior of the container toward the blade assembly.

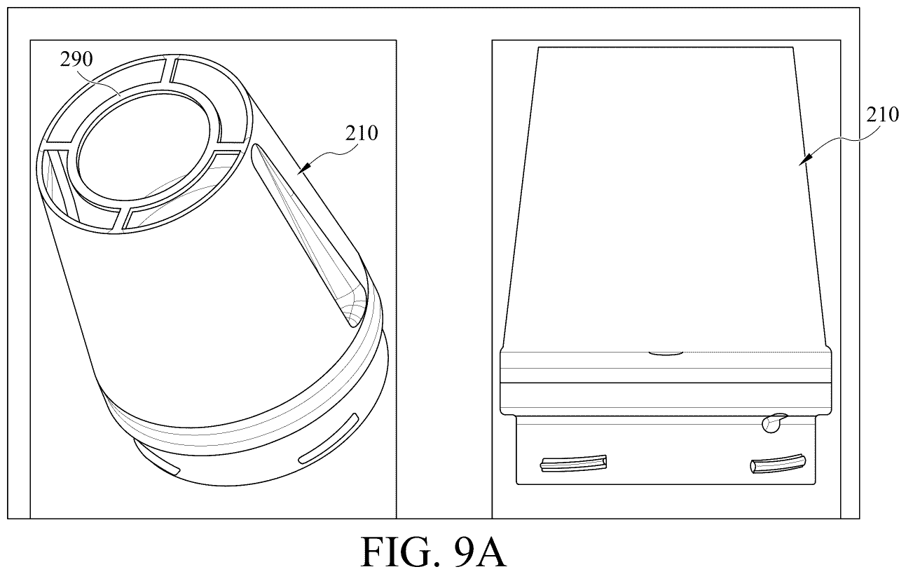

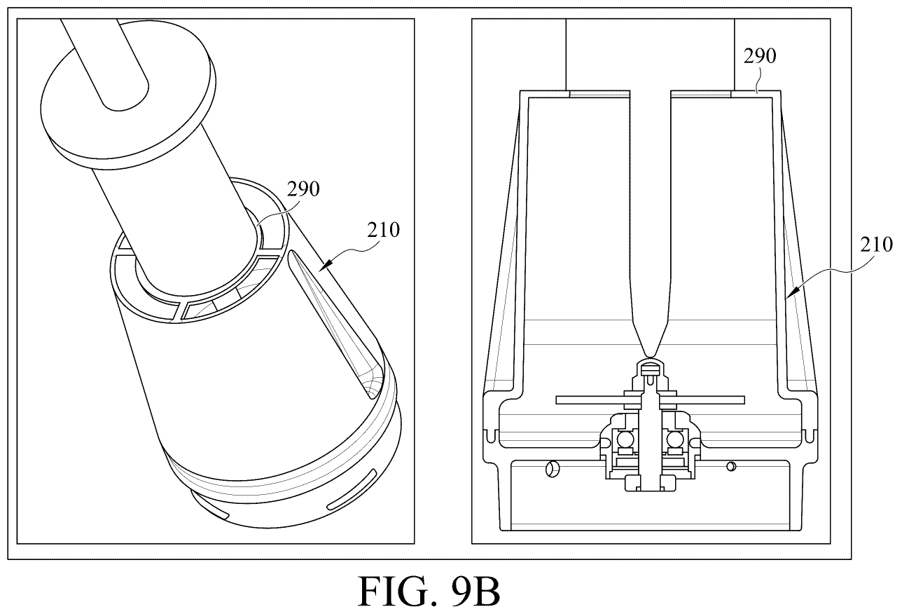

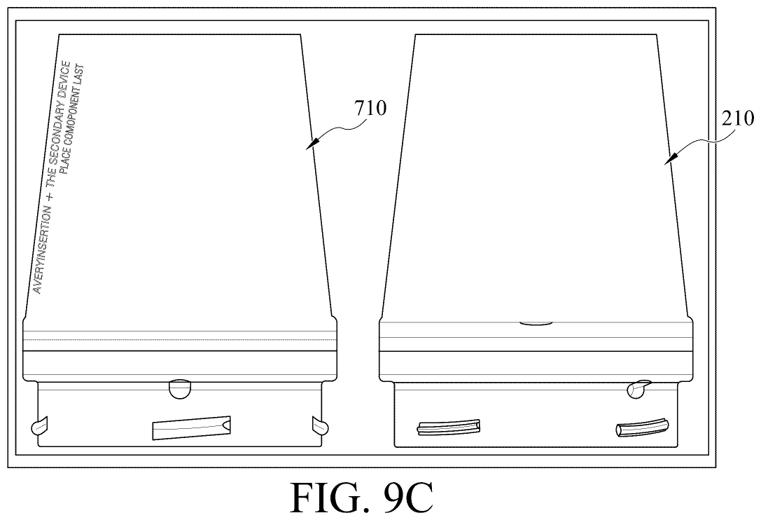

Shown in FIGS. 8, 9B, 10B, and 11B, is a gauge or probe. The gauge may be inserted into an open end of a container. As shown in FIGS. 9B, 10B, and 11B, the gauge may engage with the rim of the container. In an example, the gauge depicts a defined distance from a rim of a container to a blade assembly. In an example, the gauge depicts a defined distance from one side of a rim to an opposite side of the rim of a container. A gauge having the same size may be shown in FIGS. 8, 9B, 10B, and 11B so that the gauge may illustrate the relative or comparative size of the containers 210, 310, 410, 510, 610, 710 including the relative or comparative distance from the rim to the blade assembly and the relative or comparative distance between opposite sides of the rim (e.g., a diameter).

FIGS. 9A-C show the container 210 including a cage 290 at an open end of the container 210. Container 210 may be similar or the same as container 710, including containers 210, 710 having the same height, in an example, see FIG. 9C. Container 210 may be similar or the same as container 710, including containers 210, 710 having the same tapered shape, in an example, see FIG. 9C. The container 210 may include tapered sidewalls that, in an example, narrow from a closed end of the container 210 to the open end of the container. Container 210 may be similar or the same as container 710, except for the cage 290 on container 210. The cage 290 may comprise a generally circular portion that mirrors the general shape of the open end, wherein the circular portion has a smaller circumference than the open end. The cage 290 may further include one or more ribs that extend from an edge of the open end of the container 210 to the circular portion and that connect the cage 290 to the container 210. The one or more ribs may provide support to the circular portion and stability for ROM. The cage 290 may be integrally formed with the container or the cage 290 may be selectively attachable to the container 210 (or container 710, for example).

The cage 290 and container 210 may allow for cleanability of the container 210. The cage 290 and container 210 may allow for pourability of blended foodstuff from the container 210. The cage 290 and container 210 may allow for portability of the container 210 and blending system including the container 210. Cage 290 may create a smaller area of access to the interior of the container 210 and may prevent or limit access to the blade assembly at the closed end. FIG. 9B shows an example of prevented access of larger items, e.g., having a circumference larger than the circular portion of the cage 290, into the interior of the container 210 and the limited access for smaller items, e.g., having a circumference smaller than the circular portion of the cage 290, into the interior of the container 210. For example, cage 290 may provide a geometry at the rim or open end of the container 210 that prevents or limits access by items having a larger diameter into the container 210.

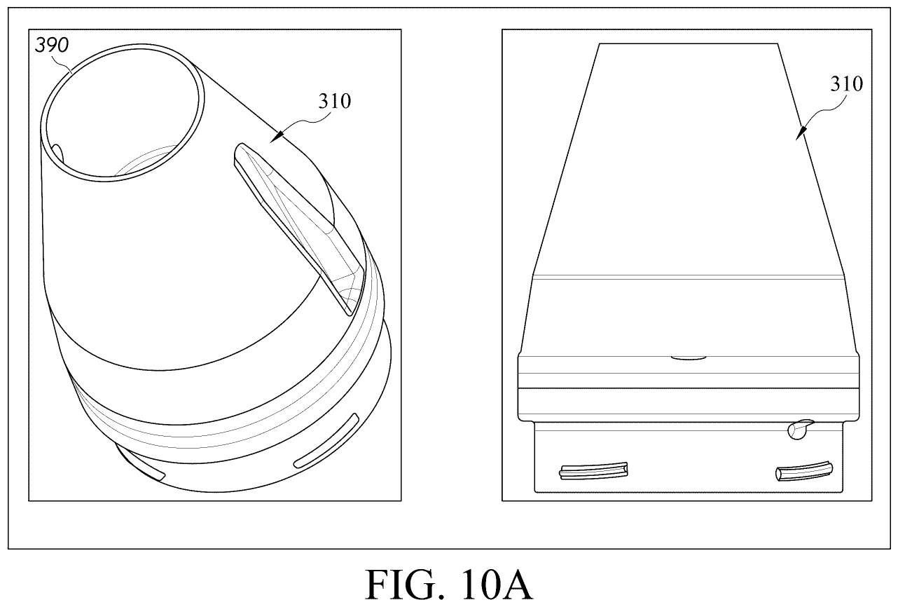

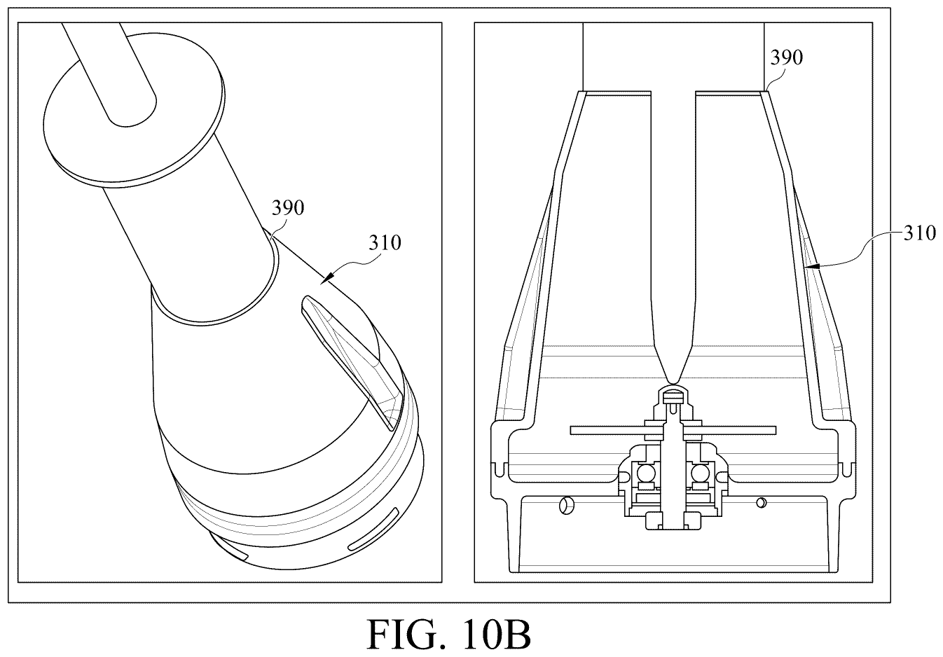

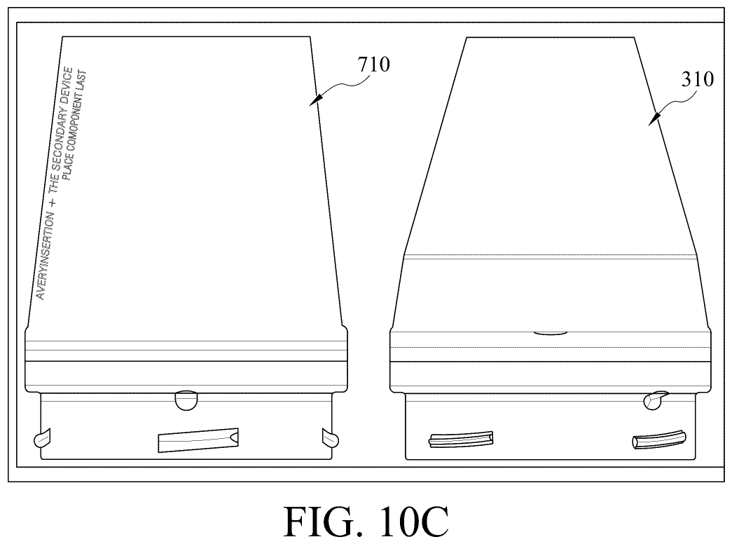

FIGS. 10A-C show the container 310 including a narrowed opening 390 defined by a rim parameter at an open end of the container 310. Container 310 may be similar or the same as container 710, including containers 310, 710 having the same height, in an example, see FIG. 10C. Container 310 may be similar or the same as container 710, except for the narrowed rim 390 on container 310. The narrowed rim 390 may include a generally circular shape and the sidewalls may have a steeper taper, e.g. decreasing in circumference, toward the open end compared to containers 210, 710. The narrowed rim 390 may be integrally formed with the container or the narrowed rim 390 may be provided as an attachment to container 710 or other container, in an example.

The narrowed rim 390 and container 310 may allow for cleanability of the container 310. The narrowed rim 390 and container 310 may allow for pourability of blended foodstuff from the container 310. The narrowed rim 390 and container 310 may allow for portability of the container 310 and blending system including the container 310. Narrowed rim 390 may create a smaller area of access to the interior of the container 310 and may prevent or limit access to the blade assembly at the closed end. FIG. 10B shows an example of prevented access of larger items, e.g., having a circumference larger than the narrowed rim 390, into the interior of the container 310 and the limited access for smaller items, e.g., having a circumference smaller than the narrowed rim 390, into the interior of the container 310. For example, narrowed rim 390 may provide a geometry at the rim or open end of the container 310 that prevents or limits access by items having a larger diameter into the container 310.

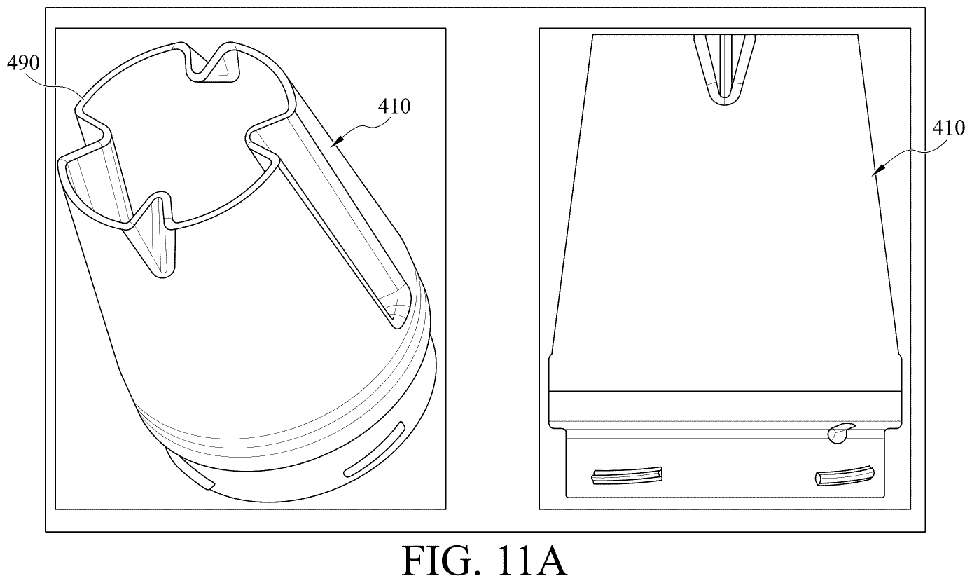

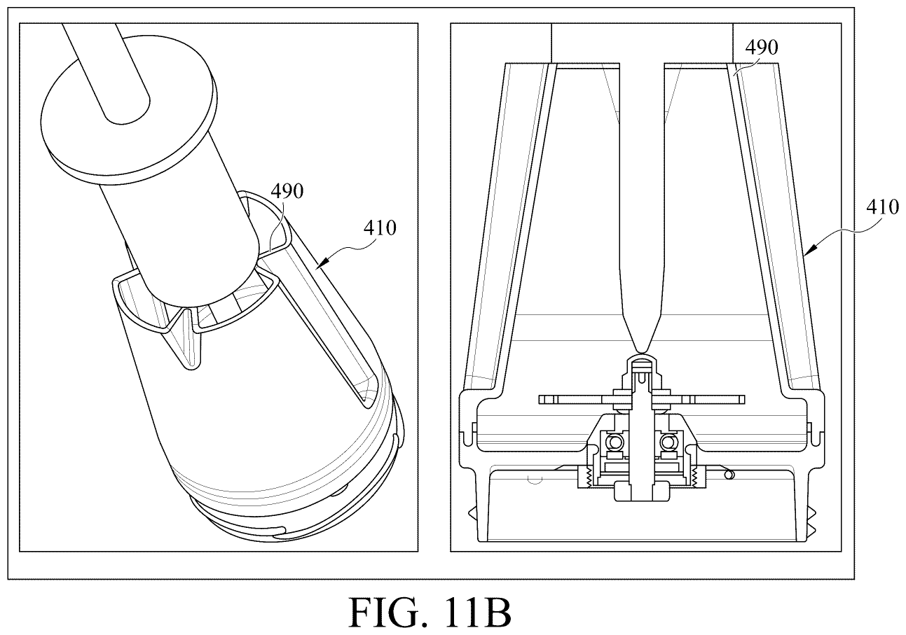

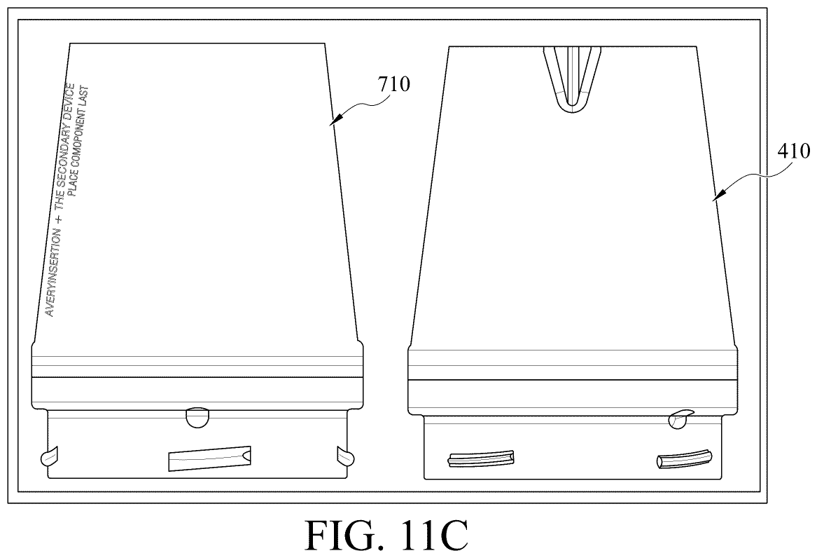

FIGS. 11A-C show the container 410 including a plurality of angled ribs 490 at an open end of the container 410. Container 410 may be similar or the same as container 710, including containers 410, 710 having the same height, in an example, see FIG. 11C. Container 410 may be similar or the same as container 710, including containers 410, 710 having the same tapered shape, in an example, see FIG. 11C. The container 410 may include tapered sidewalls that, in an example, narrow from a closed end of the container 410 to the open end of the container. Container 410 may be similar or the same as container 710, except for the angled ribs 490 on container 410. The angled ribs 490 may extend substantially the length of the sidewall, e.g., long angled ribs, or the angled ribs 490 may extend a top portion of the sidewall, e.g., short angled ribs. The long angled rims and short angled ribs, or angled ribs 490 of any other length, may extend to and through the open end or rim of the container. FIG. 11A, for example, shows container 410 having two long angled ribs opposite each other and two short angled ribs opposite each other, wherein all four angled ribs 490 are equidistant each other around the circumference of the rim or open end of the container 410. It is noted that a different number of short angled ribs and long angled ribs, and angled ribs 490 generally, may be used, as well as any combination in lengths of the angled ribs 490 and any position around the rim or open end of the container 410.

The rim of the container 410 may comprise a generally circular portion aside from the angled ribs 490. In between each angled rib 490 may comprise an opening or portion having an increased diameter. The openings or portions may allow for pouring of blended foodstuff. The rim of the container 410, aside from the angled ribs 490, may have generally the same diameter as container 210. For example, the largest diameter of the rim of container 410 may be generally the same diameter as container 210. The angled ribs 490 may be angled inward toward the interior of the container 410 to provide portions of the open end having a smaller diameter. The angled ribs 490 may be integrally formed with the container or the angled ribs 490 may be provided as an attachment to container 710 or other container, in an example.

The angled ribs 490 and container 410 may allow for cleanability of the container 410. The angled ribs 490 and container 410 may allow for pourability of blended foodstuff from the container 410. The angled ribs 490 and container 410 may allow for portability of the container 410 and blending system including the container 410. Angled ribs 490 may create a smaller area of access to the interior of the container 410 and may prevent or limit access to the blade assembly at the closed end. FIG. 11B shows an example of prevented access of larger items, e.g., items having a circumference greater than a size of the container opening defined by the angled ribs 490, into the interior of the container 410 and the limited access for smaller items, e.g., having a circumference smaller than the indent provided by the angled ribs 490, into the interior of the container 410. For example, the indent provided by the angled ribs 490 may provide a geometry at the rim or open end of the container 410 that prevents or limits access by items having a larger diameter into the container 410.

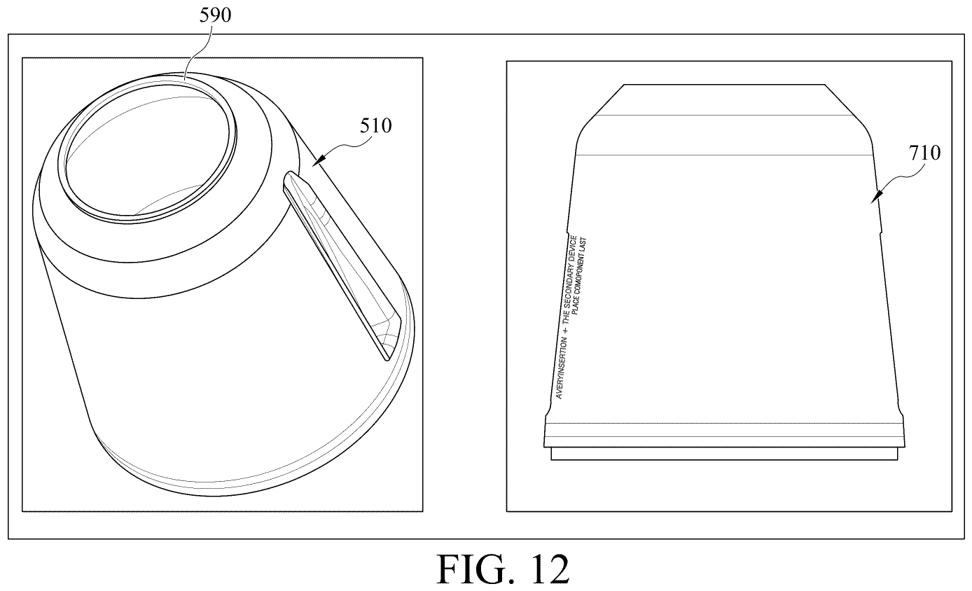

FIG. 12 shows container 510 including a narrowed rim 590 at an open end of the container 510. Container 510 may be similar to container 310 shown in FIGS. 10A and 10B except container 310 may comprise a more linear or straight (but tapered) sidewall and container 510 may comprise a sloped sidewall (having a steeper slope) adjacent the open end. Container 510 may be similar to containers 210, 710 in that the interior of the containers and blending zone or capacity may be generally unchanged between containers 210, 510, 710 except at the open end or rim (compared to container 310, for example, which may have a more sever slope across a larger portion of the sidewalls).

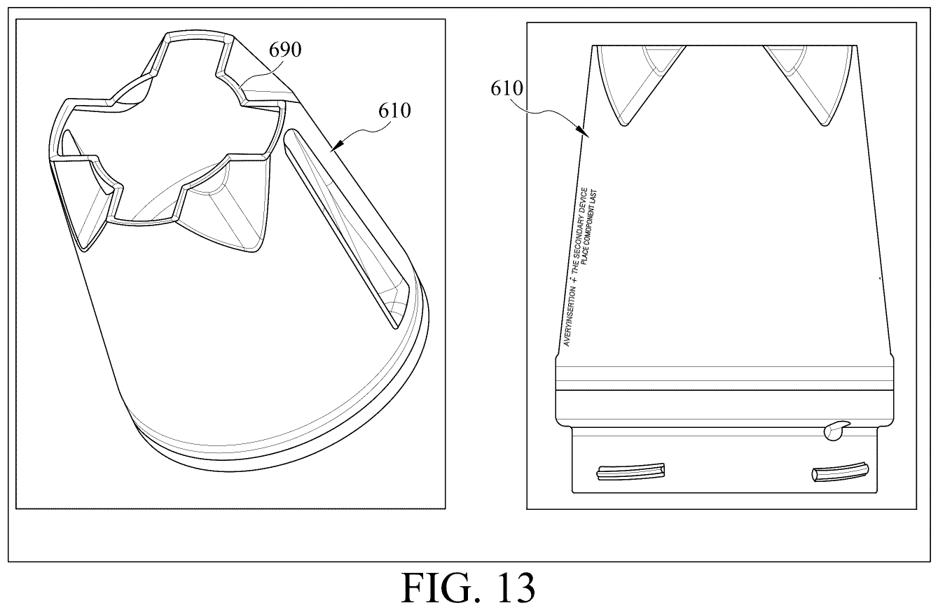

FIG. 13 shows container 610 including a plurality of angular indents 690 at an open end of the container 610. Container 610 may be similar to container 410 shown in FIGS. 11A and 11B except the angular indents 690 may include a 3-sided shape such as two angled sides and a back surface connecting the two angled sides. As with the angled ribs 490 of container 410, the angular indents 690 of container 610 may include two sets opposite each other, wherein all four angular indents 690 are equidistant each other around the circumference of the rim or open end of the container 610. In between each angular indent 690 may include an opening or portion having an increased diameter. The openings or portions may allow for pouring of blended foodstuff. All of the angular indents 690 may have the same shape. It is noted that a different number of angular indents, and the length or shape thereof, may be used, as well as any position around the rim or open end of the container 610. For example, container 610 may be modified to have three openings or angular indents 690.

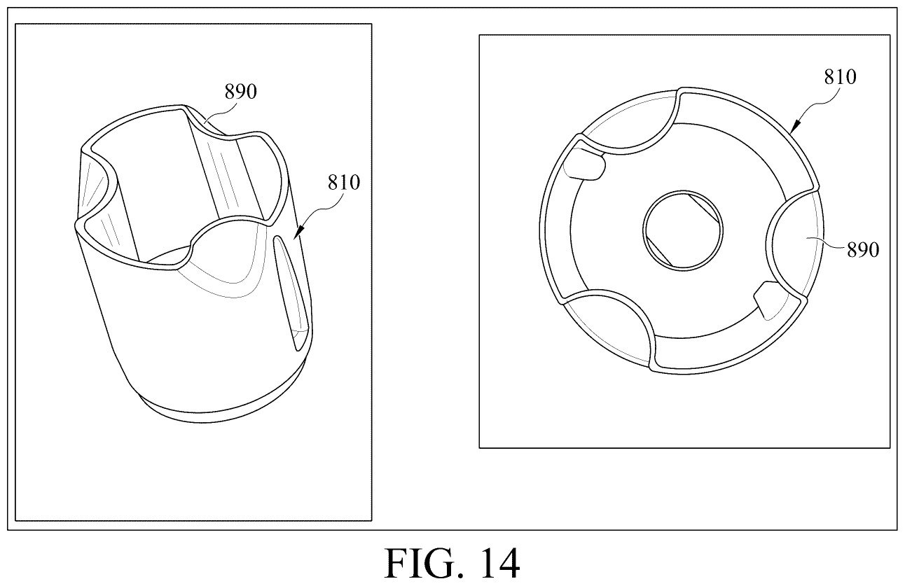

FIG. 14 shows a container 810 including a plurality of rounded indents 890 at an open end of the container 810. Container 810 may be similar to container 410 shown in FIGS. 11A and 11B and container 610 shown in FIG. 13 except the rounded indents 890 may be rounded or curved. As shown in FIG. 14, container 810 may have three rounded indents 890, wherein all three rounded indents 890 are equidistant each other around the circumference of the rim or open end of the container 810. As with the angled ribs 490 of container 410 and the angular indents 690 of container 610, it is noted that the rounded indents 890 of container 810 may alternatively include two sets opposite each other, wherein all four rounded indents 890 are equidistant each other around the circumference, or perimeter, of the rim or open end of the container 810 (just as containers 410, 610 etc. may alternatively include three equidistant indents or protrusions like that shown in FIG. 14). In between each rounded indent 890 may include an opening or portion having an increased diameter. The openings or portions may allow for pouring of blended foodstuff. All of the rounded indents 890 may have the same shape. It is noted that a different number of rounded indents, and the length or shape thereof, may be used, as well as any position around the rim or open end of the container 810. For example, container 810 may be modified to have two openings or rounded indents 890, five openings or rounded indents 890, and the like.

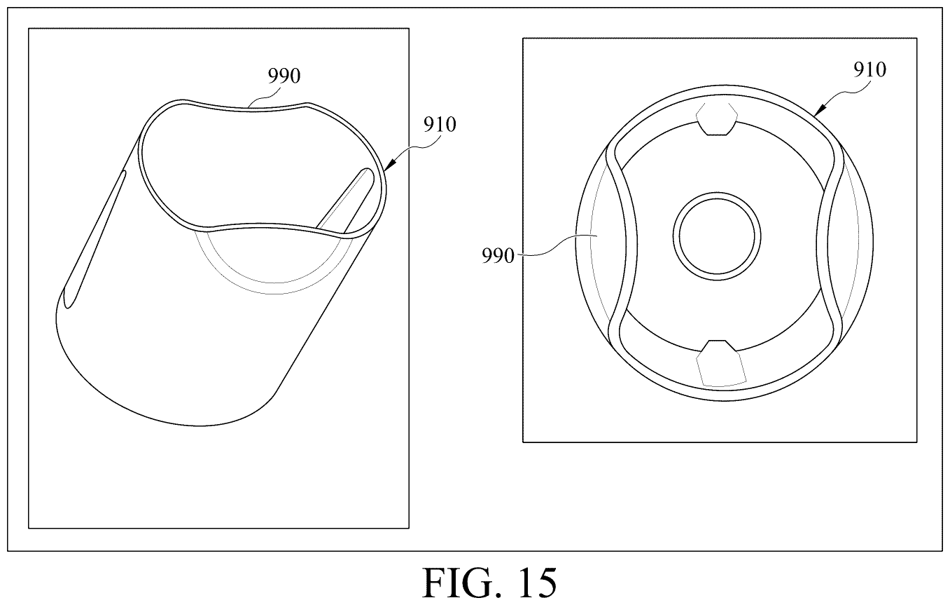

FIG. 15 shows a container 910 including a plurality of inwardly flattened or curved sides 990 at an open end of the container 910. Container 910 may be similar to container 810 shown in FIG. 14 except the inwardly curved sides 990 may be larger or longer than the rounded indents 890 of container 810. As shown in FIG. 15, container 910 may have two inwardly curved sides 990 opposite and equidistant each other around the circumference of the rim or open end of the container 910.

As with the angled ribs 490 of container 410 and the angular indents 690 of container 610, it is noted that the inwardly curved sides 990 of container 910 may alternatively include two sets opposite each other, wherein all four rounded indents 890 are equidistant each other around the circumference of the rim or open end of the container 810 (just as containers 410, 610 etc. may alternatively include two equidistant indents or protrusions like that shown in FIG. 15). As with the rounded indents 890 of container 810, it is noted that the inwardly curved sides 990 of container 910 may alternatively include three inwardly curved sides 990 equidistant each other around the circumference of the rim or open end of the container 910 (just as containers 810, etc. may alternatively include two equidistant indents or protrusions like that shown in FIG. 15).

In between each inwardly curved side 990 may include an opening or portion having an increased diameter. The openings or portions may be shaped to allow for pouring of blended foodstuff. All of the inwardly curved sides 990 may have the same shape. It is noted that a different number of inwardly curved sides, and the length or shape thereof, may be used, as well as any position around the rim or open end of the container 910. For example, container 610 may be modified to have one opening or inwardly curved side 990, five openings or inwardly curved sides 990, and the like.

The described containers may have a rim or open end geometry that prevents access to its interior (e.g., towards the blade) of certain sized objects while also including wider diameter portions that can provide pourability of a blended food product from the containers. The containers may include a rim or open end geometry that includes a series of alternating indents having a decreased diameter (compared to the protrusions) and protrusions having an increased diameter (compared to the indents).

It is noted that the geometries of any of the foregoing containers may be combined. For example, a container having at least one angular indent 690 as shown in respect to container 610 in FIG. 13, at least one rounded indent 890 as shown in respect to container 810 in FIG. 14, and the like. For example, the narrowed rim 590 as shown in respect to container 510 in FIG. 12 may include at least one angular indent 690, rounded indent 890, inwardly curved side 990, etc. Any of the foregoing containers may include a spout on its rim or open end to direct pouring of blended foodstuff. In an embodiment, the spout or adjacent rim areas may contribute to the rim or open end geometry that prevents access to its interior (e.g., towards the blade) of certain sized objects. The containers may include one or more ribs on the body of the container. In an embodiment, the ribs may align with the indents or protrusions of the rim or open end of the containers. In an embodiment, the ribs may extend to the rim or open end of the containers and contribute to the rim or open end geometry that prevents access to its interior (e.g., towards the blade) of certain sized objects.

Blending devices may be inverted when the container is still attached to the motor base to pour the blended product. The container may not need to be removed from the motor base in order to pour the blended product. The container can be selectively removed or separated from the motor base for easy, quick, of convenient cleaning, for example. In an embodiment, the container may be inverted and cleaned on a rinser.

Blending devices may be battery operated and/or rechargeable, having a charging base. In an example, the blending device or components thereof, may be placed on a drying rack and may be inductively charged. The unit may be charged while hanging upside down. In an example, the container may be rinsed prior to charging, or the container may be rinsed while charging, etc. The motor base may be fully sealed (e.g. with no cords, removable battery covers, or plug-in ports). Blending devices may allow the user freedom of movement and speed of production. Blending devices may allow for a small batch quantity or single serve quantity. It is noted that blending devices having larger capacities may also be used. It is noted that blending devices having an inverted blending may be used.

As described, the blending system 100, firmware logic, and sensing components or sensors 108 may allow the resulting blended product or foam to be repeatable and robust no matter who is prepping the ingredients or drink. The processes and blending system 100 described herein may also be used for other purposes than recipe consistency, and can be adapted for food safety and user safety applications as well.

In an example, sensors 108 may be integrated into the blending system 100 of blending devices that recognize when the container is removed or attached to the motor base or used to create a recipe. In one embodiment, the sensor or sensors 108 may comprise a near field component or and radio frequency identification (RFID) that is able to detect when the container is operatively attached to the motor base. The blending system 100 can monitor the number of uses of the container between washing and alert the user when the container needs to be washed. For example, to comply with National Sanitation Foundation (NSF) specifications, containers are supposed to be washed every 4 hours. The blending system 100 and sensors 108 could help to make sure health requirements are being met. If the container is not removed from the motor base after a certain period of time, e.g., 4 hours, or if the container is removed from the motor base a certain number of times, or used for a certain number of recipes, the blending system 100 can indicate to the user that the container needs to be washed and in some embodiments, can prevent the blending system 100 from operating until it has gone through the appropriate cleaning process. The blending system 100 can illuminate an indicator light, or make a sound, can present a notification or error message, and can prevent the operation of the motor until confirmed cleaned, removed from the motor base.

In another example, the sensors 108 may include water sensor or pressure sensors. The sensors 108 may be added to the motor base. The sensors 108 can monitor and indicate if any of the seals have been compromised. The blending system 100 can illuminate an indicator light, or make a sound, can present a notification or error message, and can prevent the operation of the motor until the seal is fixed, or operate in a safe mode. It is noted that the sensors 108 and blending system 100 as described herein may be used to monitor and alert any type of failure in the blending system.

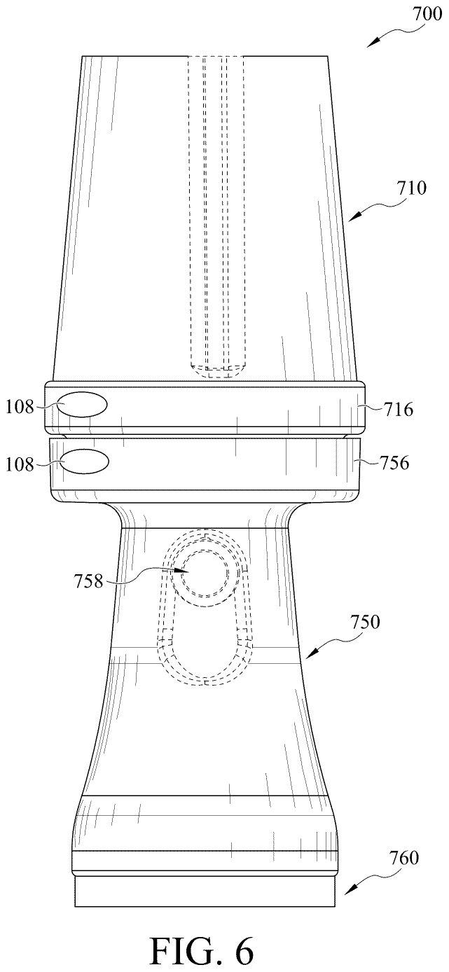

In another embodiment, the blending system 100 may include a wireless charging system. The motor base may be fully sealed (e.g. with no cords, removable battery covers, or plug-in ports) but may still be chargeable. This charging system may also allow data to be transferred through the wireless connection. This would allow the blending system 100 and/or blending systems to download data parameters into the charging pad (which would likely have an internet of things module in it) and the charger could push data to the cloud on error messages, load profiles, run data, etc. Each unit could be serialized so the charging bases would not need to be specifically linked to the correct motor base but any motor base could be put onto the charger. An embodiment of the removable charging bases selectively attachable to motor bases is shown in FIG. 6, for example.

In an embodiment, the container may be made of triton. The containers may include a tint, such as a high gloss smoke tint.

### EXAMPLES

A blending container having a body is disclosed. The body comprises a first end defining an opening, a second end positioned opposite the first end, and a sidewall extending between the first end and the second end. The sidewall comprises a first indent extending toward a center of the blending container at the first end, the first indent having a first indent radius that is defined between the first indent and the center of the blending container, and a first channel positioned adjacent the first indent at the first end, the first channel having a first channel radius that is defined between the first channel and the center of the blending container. The first channel radius is greater than the first indent radius.

The blending container according to any one of the previous examples, further comprising a second indent, wherein the first indent comprises a first geometry, wherein the second indent comprises a second geometry, and wherein the first geometry is different than the second geometry.

The blending container according to any one of the previous examples, further comprising a second indent, wherein the first indent extends a first length along the sidewall from the first end toward the second end, wherein the second indent extends a second length along the sidewall from the first end toward the second end, and wherein the first length is different than the second length.

The blending container according to any one of the previous examples, wherein the first indent comprises a rounded geometry.

The blending container according to any one of the previous examples, wherein the first indent comprises a curved geometry.

The blending container according to any one of the previous examples, wherein the first indent comprises a flattened geometry.

The blending container according to any one of the previous examples, further comprising a second indent, wherein the first indent and the second indent are spaced equidistant around a circumference of the first end of the blending container.

The blending container according to any one of the previous examples, wherein the first indent reduces an area of the opening at the first end.

A blending container comprising a body is disclosed. The body comprises, a first end defining an opening, a second end positioned opposite the first end, and a sidewall extending between the first end and the second end. The sidewall comprises a first projection extending toward a center of the blending container at the first end, the first projection reducing an area of the opening at the first end, and the first projection having a first projection distance defined between the first projection and the center of the blending container, and a first channel positioned adjacent the first projection at the first end, the first channel having a first channel distance defined between the first channel and the center of the blending container. The first channel distance is greater than the first projection distance.

The blending container according to any one of the previous examples, further comprising a second projection, wherein the first projection comprises a first geometry, wherein the second projection comprises a second geometry, and wherein the first geometry is different than the second geometry.

The blending container according to any one of the previous examples, further comprising a second projection, wherein the first projection extends a first length of the sidewall from the first end toward the second end, wherein the second projection extends a second length of the sidewall from the first end toward the second end, and wherein the first length is different than the second length.

The blending container according to any one of the previous examples, wherein the first projection comprises a rounded geometry.

The blending container according to any one of the previous examples, wherein the first projection comprises a flattened geometry.

The blending container according to any one of the previous examples, further comprising a second projection, wherein the first projection and the second projection of projections are spaced equidistant around a perimeter of the first end.

blending container having a body is disclosed. The body comprises a first end defining an opening, a second end opposite the first end, and a wall extending a wall length between the first end and the second end to define a cavity. The wall comprises a first projection extending toward a midpoint of the blending container, the first projection extending a projection length along the wall from the first end toward the second end, the projection length being different than the wall length, and the first projection having a first projection distance that is defined between the first projection and the midpoint of the blending container and a first channel positioned adjacent the first projection, the first channel having a first channel distance that is defined between the first channel and the midpoint of the blending container. The first channel distance is greater than the first projection distance.

The blending container according to any one of the previous examples, further comprising a second projection, wherein the first projection comprises a first shape, wherein the second projection comprises a second shape, and wherein the first shape is different than the second shape.

The blending container according to any one of any one of the previous examples, further comprising a second projection, wherein the second projection extends a second length of the wall from the first end toward the second end, and wherein the second length is different than the projection length.

The blending container according to any one of the previous examples, wherein the first projection comprises a rounded shape.

The blending container according to any one of the previous examples, wherein the first projection comprises a flattened shape.

The blending container according to any one of the previous examples, further comprising a second projection, wherein the first projection and the second projection are spaced equidistant around a perimeter of the first end.

A blending system having a base and a blending container removably coupled to the base is disclosed. The blending container has a body comprising a first end defining an opening, a second end positioned opposite the first end, and a sidewall extending between the first end and the second end. The sidewall comprises a first indent extending toward a center of the blending container at the first end, the first indent having a first indent radius that is defined between the first indent and the center of the blending container and a first channel positioned adjacent the first indent at the first end, the first channel having a first channel radius that is defined between the first channel and the center of the blending container. The first channel radius is greater than the first indent radius.

The blending system according to any one of the previous examples, further comprising a firmware logic to sense a presence of a particular ingredient within the blending container.

The blending system according to any one of the previous examples, further comprising a sensor to detect a quantity of a content within the blending container.

The blending system according to any one of the previous examples, wherein the sensor comprises a weight sensor.

The blending system according to any one of the previous examples, wherein the sensor comprises a point sensor.

The blending system according to any one of the previous examples, further comprising a processor in signal communication with the sensor, the processor being to prevent an operation of the blending container in an absence of a threshold quantity of a content within the blending container.

The blending system according to any one of the previous examples, further comprising a motor housed in the base and an untethered power source to power the motor in the base.

The blending system according to any one of the previous examples, further comprising a rechargeable battery.

The blending system according to any one of the previous examples, further comprising an enclosure to removably cover the blending container.

Although the present embodiments have been illustrated in the accompanying drawings and described in the foregoing detailed description, it is to be understood that the blending system is not to be limited to just the embodiments disclosed, but that the blending system described herein is capable of numerous rearrangements, modifications and substitutions.

1. A blending container, comprising:
a body, comprising:
a first end defining an opening;
a second end positioned opposite the first end; and
a sidewall extending between the first end and the second end, wherein the sidewall comprises:
a first indent extending toward a center of the blending container at the first end, the first indent having a first indent radius that is defined between the first indent and the center of the blending container; and
a first channel positioned adjacent the first indent at the first end, the first channel having a first channel radius that is defined between the first channel and the center of the blending container,
wherein the first channel radius is greater than the first indent radius.

2. The blending container according to claim 1, further comprising a second indent,
wherein the first indent comprises a first geometry,
wherein the second indent comprises a second geometry, and
wherein the first geometry is different than the second geometry.

3. The blending container according to claim 1, further comprising a second indent,
wherein the first indent extends a first length along the sidewall from the first end toward the second end,
wherein the second indent extends a second length along the sidewall from the first end toward the second end, and
wherein the first length is different than the second length.

4. The blending container according to claim 1, wherein the first indent comprises a rounded geometry.

5. The blending container according to claim 1, wherein the first indent comprises a curved geometry.

6. The blending container according to claim 1, wherein the first indent comprises a flattened geometry.

7. The blending container according to claim 1, further comprising a second indent,
wherein the first indent and the second indent are spaced equidistant around a circumference of the first end of the blending container.

8. The blending container according to claim 1, wherein the first indent reduces an area of the opening at the first end.

9.-20. (canceled)

21. A blending system, comprising:
a base; and
a blending container removably coupled to the base, the blending container comprising:
a body, comprising:
a first end defining an opening;
a second end positioned opposite the first end; and
a sidewall extending between the first end and the second end, wherein the sidewall comprises:
a first indent extending toward a center of the blending container at the first end, the first indent having a first indent radius that is defined between the first indent and the center of the blending container; and
a first channel positioned adjacent the first indent at the first end, the first channel having a first channel radius that is defined between the first channel and the center of the blending container,
wherein the first channel radius is greater than the first indent radius.

22. The blending system according to claim 21, further comprising a firmware logic to sense a presence of a particular ingredient within the blending container.

23. The blending system according to claim 21, further comprising a sensor to detect a quantity of a content within the blending container.

24. The blending system according to claim 23, wherein the sensor comprises a weight sensor.

25. The blending system according to claim 21, wherein the sensor comprises a point sensor.

26. The blending system according to claim 21, further comprising a processor in signal communication with the sensor, the processor being to prevent an operation of the blending container in an absence of a threshold quantity of a content within the blending container.

27. The blending system according to claim 21, further comprising a motor housed in the base and an untethered power source to power the motor in the base.

28. The blending system according to claim 21, further comprising a rechargeable battery.

29. The blending system according to claim 21, further comprising an enclosure to removably cover the blending container.

30. The blending container according to claim 1, wherein the first indent is an elongate indent extending from the first end towards the second end.

31. The blending container according to claim 1, wherein the sidewall is tapered inwardly from the second end towards the first end.

32. A blending container, comprising:
a body comprising:
a first end defining an opening,
a second end positioned opposite the first end, the second end being closed at a base, and
a tapered sidewall extending from the first end to the second end, wherein a first radius of the sidewall at the first end is less than a second radius of the sidewall at the second end; and
a frothing device disposed at the second end of the body, the frothing device configured to be driven by a motor.
